(19) United States
(12) Patent Application Publication
(10) Pub. No.: US 2016/0058015 A1
(43) Pub. Date: Mar. 3, 2016

(54) METHOD OF CONTROLLING WEED IN A SUGARCANE FIELD

(71) Applicant: SUMITOMO CHEMICAL COMPANY, LIMITED, Tokyo (JP)

(72) Inventor: Hajime IKEDA, Kasai-shi (JP)

(21) Appl. No.: 14/472,062

(22) Filed: Aug. 28, 2014

(51) Int. Cl. A01N 63/00; A01N 43/82; A01N 43/54; A01N 43/84; A01N 43/653

(52) U.S. Cl. CPC A01N 63/00; A01N 43/84; A01N 43/653; A01N 43/54; A01N 43/82

(57) ABSTRACT

To provide a technology for controlling weeds and the like. A method of controlling a weed in a sugarcane field, comprising applying one or more PPO-inhibiting compounds selected from Group A to a field before, at or after planting a stem cutting of sugarcane treated with one or more microorganisms selected from the group consisting of Gluconacetobacter species, Herbaspirilum species, Azospirilum species, and Burkholderia species:

Group A:
a group consisting of flumioxazin, sulfentrazone, saflufenacil, oxyfluorfen, fomesafen, oxadiazon and a compound represented by the formula (I):

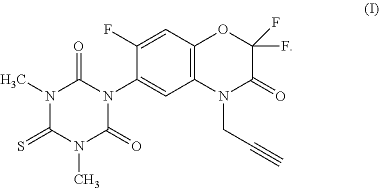 [SMILES: C#CCN1C(=O)C(F)(F)Oc2cc(F)c(-n3c(=O)n(C)c(=S)n(C)c3=O)cc21]

### BACKGROUND OF THE INVENTION

1. Field of the Invention

The present invention relates to a method of controlling a weed in a field of sugarcane.

2. Description of the Related Art

Sugarcane is a crop containing sugar at a large amount and used for the production of bioethanol. The importance of this crop has been increasing as an energy source which is reproducible and hardly generates an environmental problem.

A weed is one of the major problems for the cultivation of sugarcane. Currently, many herbicides are sold and used for sugarcane and PPO-inhibiting compounds are well-known as herbicides, however, more effective weeding methods are required.

### PRIOR ART LITERATURE

### Non Patent Literature

Non-Patent Document 1: Crop Protection Handbook, vol. 98 (2012)(Meister Publishing Company, ISBN: 1-892829-25-8)

### SUMMARY OF INVENTION

### Technical Problem

An object of the present invention is to provide a method which exerts the excellent controlling effect on a weed, without causing significant phytotoxicity on sugarcane, in a sugarcane field.

### Solution of Problem

The present invention is a method of controlling a weed in a sugarcane field by applying a PPO-inhibiting compound to a field of sugarcane, before, at or after planting a stem cutting of sugarcane treated with one or more microorganisms as biological agents.

The present invention is as follows.

[1] A method of controlling a weed in a sugarcane field, comprising applying one or more PPO-inhibiting compounds selected from Group A to a field before, at or after planting a stem cutting of sugarcane treated with one or more microorganisms selected from the group consisting of Gluconacetobacter species, Herbaspirilum species, Azospirilum species, and Burkholderia species, wherein Group A is a group consisting of flumioxazin, sulfentrazone, saflufenacil, oxyfluorfen, fomesafen, oxadiazon and a compound represented by the formula (I):

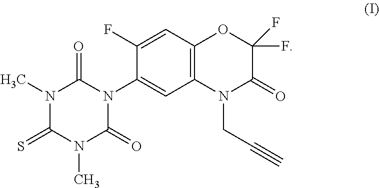 [SMILES: C#CCN1C(=O)C(F)(F)Oc2cc(F)c(-n3c(=O)n(C)c(=S)n(C)c3=O)cc21]

[2] The method according to [1], wherein the one or more microorganisms is selected from the group consisting of Azospirillum amazonense, Herbaspirillum seropedicae, Herbaspirillum rubrisubalbicans, Burkholderia tropica and Gluconacetobacter diazotrophicus.

[3] The method according to [1] or [2], wherein the stem cutting of sugarcane is further treated with one or more microorganisms selected from the group consisting of Pseudomonas fluorescens, Pseudomonas putida, Streptomyces griseus, Streptomyces ochraceisleroticus, Streptomyces graminofaciens, Streptomyces corchousii, Streptomyces spiroverticillatus, Streptomyces griseovirdis, Streptomyces hygroscopicus, Bacillus subtilis, Bacillus cereus, Bacillus mycoides, Bacillus pumilus, Bacillus licheniformis, Bacillus thuringiensis, Trichoderma harzianum, Trichoderma viride and Sporidesmium sclerotiorum.

[4] The method according to [1] or [2], wherein the one or more PPO-inhibiting compound is flumioxazin.

[5] The method according to [3], wherein the one or more PPO-inhibiting compound is flumioxazin.

### Effect of Invention

According to the method of the present invention, a weed in a sugarcane field can be controlled without causing significant phytotoxicity on sugarcane.

In addition, according to the method of present invention, it becomes possible to increase the yield of sugarcane and the yield of sugar from a plant of sugarcane.

### DETAILED DESCRIPTION OF THE PREFERRED EMBODIMENTS

The method of controlling a weed of the present invention comprises the steps of:

(1) treating a stem cutting of sugarcane with one or more microorganisms selected from the group consisting of Gluconacetobacter species, Herbaspirilum species, Azospirilum species, and Burkholderia species, and
(2) applying one or more PPO-inhibiting compounds selected from Group A to a sugarcane field before, at or after planting the stem cutting of sugarcane treated with the one or more microorganisms:

### Group A:

a group consisting of flumioxazin, sulfentrazone, saflufenacil, oxyfluorfen, fomesafen, oxadiazon and a compound represented by the formula (I) (hereafter described as Compound 1):

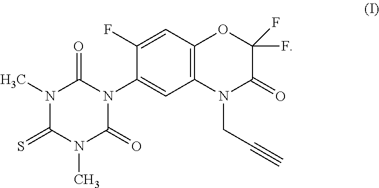 [SMILES: C#CCN1C(=O)C(F)(F)Oc2cc(F)c(-n3c(=O)n(C)c(=S)n(C)c3=O)cc21]

Sugarcane used in the method of the present invention is a Saccharum perennial Poaceae crop, and examples include Saccharum arundinaceum, Saccharum bengalense, Saccharum edule, Saccharum officinarum, Saccharum procerum, Saccharum ravennae, Saccharum robustum, Saccharum sinense, Saccharum spontaneum and a hybrid of these species.

Sugarcane used in the method of the present invention is not limited as far as it is a variety which is generally cultivated as a crop.

Examples of the crop includes crops to which resistance to a 4-hydroxyphenylpyruvate dioxygenase inhibitor such as isoxaflutole; an acetolactate synthase (hereinafter abbreviated as ALS) inhibitor such as imazethapyr or thifensulfuron methyl; a 5-enolpyruvylshikimate-3-phosphate synthase (hereinafter, abbreviated as EPSP) inhibitor such as glyphosate; a glutamine synthase inhibitor such as glufosinate; an auxin-type herbicide such as 2,4-D or dicamba; or bromoxynil has been imparted by a classical breeding method or a genetic engineering technique.

The crop includes, for example, a crop which has become possible to synthesize a selective toxin known in Bacillus genus, using a genetic engineering technique.

Examples of the toxin which is expressed in such a genetically engineered plant include an insecticidal protein derived from Bacillus cereus or Bacillus popilliae; a δ-endotoxin such as Cry1Ab, Cry1Ac, Cry1F, Cry1Fa2, Cry2Ab, Cry3A, Cry3Bb1, Cry9C, Cry34ab and Cry35ab, derived from Bacillus thuringiensis; an insecticidal protein such as VIP1, VIP2, VIP3 or VIP3A; an insecticidal protein derived from nematode; a toxin produced by an animal such as a scorpion toxin, a spider toxin, a bee toxin or an insect-specific neurotoxin; a filamentous fungus toxin; plant lectin; agglutinin; a protease inhibitor such as a trypsin inhibitor, a serine protease inhibitor, patatin, cystatin, and a papain inhibitor; a ribosome inactivating protein (RIP) such as lysine, corn-RIP, abrin, luffin, saporin or bryodin; a steroid metabolism enzyme such as 3-hydroxysteroid oxidase, ecdysteroid-UDP-glycosyltransferase, and cholesterol oxidase; an ecdysone inhibitor; HMG-CoA reductase; an ion channel inhibitor such as a sodium channel inhibitor or a calcium channel inhibitor; juvenile hormone esterase; a diuretic hormone receptor; stilbene synthase; bibenzyl synthase; chitinase; glucanase; and the like.

A toxin expressed by such a genetically engineered crop includes a hybrid toxin of a 6-endotoxin protein such as Cry1Ab, Cry1Ac, Cry1F, Cry1Fa2, Cry2Ab, Cry3A, Cry3Bbl, Cry9C, Cry34Ab or Cry35Ab, and an insecticidal protein such as VIP1, VIP2, VIP3 or VIP3A, and a partially deleted toxin, and a modified toxin. The hybrid toxin can be produced by a new combination of different domains of these proteins using a genetic engineering technique. As the partially deleted toxin, Cry1Ab in which a part of an amino acid sequence has been deleted is known. In the modified toxin, one or a plurality of amino acids of a natural toxin is substituted. Examples of these toxins and recombinant plants which can synthesize these toxins are described in EP-A-0374753, WO 93/07278, WO 95/34656, EP-A-0427529, EP-A-451878, WO 03/052073 and the like. The toxins contained in these recombinant plans impart resistance to Coleoptera vermin, Diptera vermin and Lepidoptera vermin to a plant.

The crop also includes a crop to which the ability to produce an anti-pathogenic substance having selective action has been imparted using a genetic engineering technique. As an example of the anti-pathogenic substance, a PR protein and the like are known (PRPs, EP-A-0392225). Such an anti-pathogenic substance and a genetically engineered plant producing the substance are described in EP-A-0392225, WO 95/33818, EP-A-0353191 and the like. Examples of the anti-pathogenic substance expressed in such a genetically engineered plant include an ion channel inhibitor such as a sodium channel inhibitor or a calcium channel inhibitor (KP1, KP4 and KP6 toxins, etc., which are produced by viruses, have been known); stilbene synthase; bibenzyl synthase; chitinase; glucanase; a PR protein; and an anti-pathogenic substance generated by microorganisms, such as a peptide antibiotic, an antibiotic having a hetero ring, or a protein factor associated with resistance to plant diseases (which is called a plant disease-resistant gene and is described in WO 03/000906).

The crop also includes crops to which disease resistance, drying stress resistance or a characteristic of increasing sugar content is imparted.

In commercial cultivation of sugarcane, a stem cutting having nodes with buds is usually planted. The term ‘stem cutting’ means a section of a stalk, which is a seed piece to propagate sugarcane. The term ‘node’ means the part of the stalk, where a bud and root primordia are found. The ‘bud’, located in a node, is an embryonic shoot consisting of a small stalk with small leaves.

In the method of the present invention, as a stem cutting of sugarcane, a stem cutting obtained by cutting a mature stalk of sugarcane so that the cutting has one node may be used. The size of the stem cutting of sugarcane can be 2 cm to 15 cm. The technique of cultivating sugarcane using the stem cutting is known in Patent documents (WO09/000398, WO09/000399, WO09/000400, WO09/000401 and WO09/000402), and known under the brand name of Plene (trade mark).

In the method of the present invention, a stem cutting of sugarcane is treated with one or more microorganisms selected from the group of Gluconacetobacter species, Herbaspirilum species, Azospirilum species and Burkholderia species. Exemplary species of microorganisms mentioned above includes Azospirillum amazonense, Herbaspirillum seropedicae, Herbaspirillum rubrisubalbicans, Burkholderia tropica and Gluconacetobacter diazotrophicus.

These microorganisms are known as nitrogen-fixing bacteria, which convert molecular nitrogen in the atmosphere into inorganic nitrogen compounds usable by plants. These microorganisms are all known agent, and the commercially available formulation or the one deposited in the public microbelibrary can be used.

In the method of the present invention, the stem cutting of sugarcane treated with the one or more microorganisms selected from the group of Gluconacetobacter species, Herbaspirilum species, Azospirilum species and Burkholderia species can be further treated with one or more other microorganisms such as bacteria and fungi as biological control agents, preferably selected from the group consisting of Pseudomonas fluorescens, Pseudomonas putida, Streptomyces griseus, Streptomyces ochraceisleroticus, Streptomyces graminofaciens, Streptomyces corchousii, Streptomyces spiroverticillatus, Streptomyces griseovirdis, Streptomyces hygroscopicus, Bacillus subtilis, Bacillus cereus, Bacillus mycoides, Bacillus pumilus, Bacillus licheniformis, Bacillus thuringiensis, Trichoderma harzianum, Trichoderma viride, and Sporidesmium sclerotiorum.

These other microorganisms are all known agent, and the commercially available formulation or the one deposited in the public microbelibrary can be used.

In the step of treating a stem cutting of sugarcane with the microorganism in the present invention, the microorganism is usually formulated by mixing with a carrier such as a solid carrier and a liquid carrier, and further adding an adjuvant for formulation such as a surfactant, as necessary. The preferable formulation form is an aqueous liquid suspension.

The amount of a microorganism is in the range of usually from 0.002 to 50 g, preferably from 0.01 to 10 g, more preferably from 0.05 to 2 g, and still more preferably from 0.1 to 1 g per 1 kg of stem cuttings of sugarcane.

Examples of the method of treating a stem cutting of sugarcane with a microorganism include a method of dust-coating a formulation containing an active ingredient on a stem cutting, a method of immersing a stem cutting in a formulation containing a microorganism, a method of spraying a formulation containing a microorganism on a stem cutting, and a method of coating a stem cutting with a carrier containing a microorganism. Injection of microorganism directly into a stem cutting by a needle is also an example of the method in the present invention.

The stem cutting of sugarcane used in the method of the present invention may be further treated with an agrochemical such as an insecticide, a nematicide, a fungicide, a plant growth controlling agent and a safener, as needed, before planting.

Examples of the agrochemicals include the following:

Insecticides: clothianidin, thiamethoxam, imidacloprid, dinotefuran, nitenpyram, acetamiprid and thiacloprid, abmectin, fipronil, carbofuran.

Nematicide: fosthiazate.

Fungicides: kresoxim-methyl, azoxystrobin, trifloxystrobin, fluoxastrobin, picoxystrobin, pyraclostrobin, dimoxystrobin, pyribencarb, metominostrobin, orysastrobin, enestrobin, pyraoxystrobin, pyrametostrobin, azaconazole, bitertanol, bromuconazole, cyproconazole, difenoconazole, diniconazole, epoxiconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimenol, triticonazole, fenarimol, nuarimol, pyrifenox, imazalil, oxpoconazole fumarate, pefurazoate, prochloraz, triflumizole, metalaxyl and metalaxyl-M.

Plant growth controlling agents: hymexazol, paclobutrazol, uniconazole, uniconazole-P, inabenfide, prohexadione-calcium, 1-methylcyclopropene, trinexapac and gibberellins.

Safeners: benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthalic anhydride and oxabetrinil.

The PPO-inhibiting compound is a herbicidally active compound which inhibits protoporphyrinogen IX oxidase (EC1.3.3.4) located on a chlorophyll synthesis route in a plastid of a plant and, as a result, leads to withering of the plant.

The PPO-inhibiting compound used in the method of the present invention is flumioxazin, sulfentrazone, saflufenacil, oxyfluorfen, fomesafen and a salt thereof, oxadiazon and Compound 1.

Flumioxazin, sulfentrazone, saflufenacil, oxyfluorfen, fomesafen and a salt thereof, and oxadiazon are well known herbicidally active compounds described in Crop Protection Handbook, vol. 98 (2012)(Meister Publishing Company, ISBN: 1-892829-25-8), and can be produced by the known processes, and commercially available preparations containing them can be obtained.

Fomesafen used in the method of the present invention may be a form of an acid, or a salt such as a formesafen sodium salt (fomesafen-sodium).

Compound 1 is a herbicidal active compound described in WO 10/145992 and can be produced by a method described in this publication.

In the step of applying one or more PPO-inhibiting compounds selected from Group A to a sugarcane field, the PPO-inhibiting compound is mixed with a solid carrier or a liquid carrier, formulated with optional addition of an auxiliary agent for formulation such as a surfactant, and then used.

Examples of a method of applying the PPO-inhibiting compound to a sugarcane field include a method of spraying the PPO-inhibiting compound on a soil of a field, and a method of spraying the PPO-inhibiting compound on a weed after development of the weed.

An amount of the PPO-inhibiting compound used in the step of applying the PPO-inhibiting compound to a sugarcane field is usually from 5 to 5000 g, and preferably from 25 to 400 g per 10000 m². In the step of applying the PPO-inhibiting compound to a sugarcane field, an adjuvant may be mixed upon treatment with the PPO-inhibiting compound.

The stem cutting of sugarcane treated with the one or more microorganisms in the present invention is planted in a field by the usual method.

In the method of the present invention, the PPO-inhibiting compound may be applied to a field before planting a stem cutting of sugarcane in the field, may be applied to a field simultaneously at planting a stem cutting of sugarcane in the field, or may be applied to a field after planting a stem cutting of sugarcane in the field.

When the PPO-inhibiting compound is applied to a field before planting a stem cutting of sugarcane in the field, the PPO-inhibiting compound is applied to the field from 40 days before planting to before planting, preferably 30 days before planting to immediately before planting, further preferably 20 days before planting to immediately before planting.

When the PPO-inhibiting compound is applied to a field after planting a stem cutting of sugarcane in the field, the PPO-inhibiting compound is applied to the field from before a shoot of sugarcane emerges. The term ‘shoot’ means the first part of a plant to appear above the ground from a seed or a vegetative organ. The shoot of sugarcane may be that from newly planted cane or ratoon after having been harvested.

According to the method of the present invention, a weed in a sugarcane field can be controlled.

Examples of the weed include the followings:

Urticaceae weeds: Urtica urens

Polygonaceae weeds: Polygonum convolvulus, Polygonum lapathifolium, Polygonum pensylvanicum, Polygonum persicaria, Polygonum longisetum, Polygonum aviculare, Polygonum arenastrum, Polygonum cuspidatum, Rumex japonicus, Rumex crispus, Rumex obtusifolius, Rumex acetosa

Portulacaceae weeds: Portulaca oleracea

Caryophyllaceae weeds: Stellaria media, Cerastium holosteoides, Cerastium glomeratum, Spergula arvensis, Silene gallica

Aizoaceae weeds: Mollugo verticillata

Chenopodiaceae weeds: Chenopodium album, Chenopodium ambrosioides, Kochia scoparia, Salsola kali, Atriplex spp.

Amaranthaceae weeds: Amaranthus retroflexus, Amaranthus viridis, Amaranthus lividus, Amaranthus spinosus, Amaranthus hybridus, Amaranthus palmeri, Amaranthus rudis, Amaranthus patulus, Amaranthus tuberculatos, Amaranthus blitoides, Amaranthus deflexus, Amaranthus quitensis, Alternanthera philoxeroides, Alternanthera sessilis, Alternanthera tenella

Papaveraceae weeds: Papaver rhoeas, Argemone mexicana

Brassicaceae weeds: Raphanus raphanistrum, Raphanus sativus, Sinapis arvensis, Capsella bursa-pastoris, Brassica juncea, Brassica campestris, Descurainia pinnata, Rorippa islandica, Rorippa sylvestris, Thlaspi arvense, Myagrum rugosum, Lepidium virginicum, Coronopus didymus

Capparaceae weeds: Cleome affinis

Fabaceae weeds: Aeschynomene indica, Aeschynomene rudis, Sesbania exaltata, Cassia obtusifolia, Cassia occidentalis, Desmodium tortuosum, Desmodium adscendens, Trifolium repens, Pueraria lobata, Viola angustifolia, Indigofera hirsuta, Indigofera truxillensis, Vigna sinensis

Oxalidaceae weeds: Oxalis corniculata, Oxalis strica, Oxalis oxyptera

Geraniaceae weeds: Geranium carolinense, Erodium cicutarium

Euphorbiaceae weeds: Euphorbia helioscopia, Euphorbia maculata, Euphorbia humistrata, Euphorbia esula, Euphorbia heterophylla, Euphorbiabrasiliensis, Acalyphaaustralis, Croton glandulosus, Croton lobatus, Phyllanthus corcovadensis, Ricinus communis

Malvaceae weeds: Abutilon theophrasti, Sida rhombiforia, Sida cordifolia, Sida spinosa, Sida glaziovii, Sida santaremnensis, Hibiscus trionum, Anoda cristata, Malvastrum coromandelianum

Sterculiaceae weeds: Waltheria indica

Violaceae weeds: Viola arvensis, Viola tricolor

Cucurbitaceae weeds: Sicyosangulatus, Echinocystis lobata, Momordica charantia

Lythraceae weeds: Lythrum salicaria

Apiaceae weeds: Hydrocotyle sibthorpioides

Sapindaceae weeds: Cardiospermum halicacabum

Primulaceae weeds: Anagallis arvensis

Asclepiadaceae weeds: Asclepias syriaca, Ampelamusalbidus

Rubiaceae weeds: Galium aparine, Galium spurium var. echinospermon, Spermacoce latifolia, Richardia brasiliensis, Borreria alata

Convolvulaceae weeds: Ipomoea nil, Ipomoea hederacea, Ipomoea purpurea, Ipomoea hederacea var. integriuscula, Ipomoea lacunosa, Ipomoea triloba, Ipomoea acuminata, Ipomoea hederifolia, Ipomoea coccinea, Ipomoea quamoclit, Ipomoea grandifolia, Ipomoea aristolochiafolia, Ipomoea cairica, Convolvulus arvensis, Calystegiahederacea, Calystegia japonica, Merremia hedeacea, Merremia aegyptia, Merremia cissoides, Jacquemontia tamnifolia

Boraginaceae weeds: Myosotis arvensis

Lamiaceae weeds: Lamium purpureum, Lamium amplexicaule, Leonotis nepetaefolia, Hyptis suaveolens, Hyptis lophanta, Leonurus sibiricus, Stachys arvensis

Solanaceae weeds: Datura stramonium, Solanum nigrum, Solanum americanum, Solanum ptycanthum, Solanum sarrachoides, Solanum rostratum, Solanum aculeatissimum, Solanum sisymbriifolium, Solanum carolinense, Physalis angulata, Physalis subglabrata, Nicandra physaloides

Scrophulariaceae weeds: Veronica hederaefolia, Veronica persica, Veronica arvensis

Plantaginaceae weeds: Plantago asiatica

Asteraceae weeds: Xanthium pensylvanicum, Xanthium occidentale, Helianthus annuus, Matricaria chamomilla, Matricaria perforata, Chrysanthemum segetum, Matricaria matricarioides, Artemisia princeps, Artemisia vulgaris, Artemisia verlotorum, Solidago altissima, Taraxacum officinale, Galinsoga ciliata, Galinsoga parviflora, Senecio vulgaris, Senecio brasiliensis, Senecio grisebachii, Conyza bonariensis, Conyza canadensis, Ambrosia artemisiaefolia, Ambrosia trifida, Bidens pilosa, Bidens frondosa, Bidens subalternans, Cirsium arvense, Cirsium vulgare, Silybum marianum, Carduus nutans, Lactuca serriola, Sonchus oleraceus, Sonchus asper, Wedelia glauca, Melampodium perfoliatum, Emilia sonchifolia, Tagetes minuta, Blainvillea latifolia, Tridax procumbens, Porophyllum ruderale, Acanthospermum australe, Acanthospermum hispidum, Cardiospermum halicacabum, Ageratum conyzoides, Eupatorium perfoliatum, Eclipta alba, Erechtites hieracifolia, Gamochaeta spicata, Gnaphalium spicatum, Jaegeria hirta, Parthenium hysterophorus, Siegesbeckia orientalis, Soliva sessilis

Liliaceae weeds: Allium canadense, Allium vineale

Commelinaceae weeds: Commelina communis, Commelina bengharensis, Commelina erecta

Poaceae weeds: Echinochloa crus-galli, Setaria viridis, Setaria faberi, Setaria glauca, Setaria geniculata, Digitaria ciliaris, Digitaria sanguinalis, Digitaria horizontalis, Digitaria insularis, Eleusine indica, Poa annua, Alospecurus aequalis, Alopecurus myosuroides, Avena fatua, Sorghum halepense, Sorghum vulgare, Agropyron repens, Lolium multiflorum, Lolium perenne, Lolium rigidum, Bromus secalinus, Bromus tectorum, Hordeum jubatum, Aegilops cylindrica, Phalaris arundinacea, Phalaris minor, Apera spica-venti, Panicum dichotomiflorum, Panicum texanum, Panicum maximum, Brachiaria platyphylla, Brachiaria ruziziensis, Brachiaria plantaginea, Brachiaria decumbens, Brachiaria brizantha, Brachiaria humidicola, Cenchrus echinatus, Cenchrus pauciflorus, Eriochloa villosa, Pennisetum setosum, Chloris gayana, Eragrostis pilosa, Rhynchelitrumrepens, Dactyloctenium aegyptium, Ischaemum rugosum, Oryza sativa, Paspalum notatum, Paspalum maritimum, Pennisetum clandestinum, Pennisetum setosum, Rottboellia cochinchinensis

Cyperaceae weeds: Cyperus microiria, Cyperus iria, Cyperus odoratus, Cyperus rotundus, Cyperus esculentus, Kyllinga gracillima

Equisetaceae weeds: Equisetum arvense, Equisetum palustre.

In the method of the present invention, the PPO-inhibiting compound can be applied to a field alone or by adding one or more kinds of other agrochemicals thereto. Examples of other agrochemical include an insecticide, a miticide, a nematocide, a fungicide, a herbicide, a plant regulating agent and a safener.

Examples of the herbicide, the plant growth regulating agent and the safener include the followings:

Herbicide: dicamba and a salt thereof (diglycolamine salt, dimethylammonium salt, isopropylammonium salt, potassium salt, sodium salt, N, N-bis-(3-aminopropyl)methylamine salt, choline salt), 2,4-D and a salt or ester thereof (butotyl ester, dimethylammonium salt, diolamine salt, ethylhexyl ester, isooctyl ester, isopropylammonium salt, sodium salt, triisopropanolamine salt, choline salt), 2,4-DB and a salt or ester thereof (dimethylammonium salt, isooctyl ester, choline salt), MCPA and a salt or ester thereof (dimethylammonium salt, 2-ethylhexyl ester, isooctyl ester, sodium salt, choline salt), MCPB, mecoprop and a salt or ester thereof (dimethylammonium salt, diolamine salt, ethadyl ester, 2-ethylhexyl ester, isooctyl ester, methyl ester, potassium salt, sodium salt, trolamine salt, choline salt), mecoprop-P and a salt or ester thereof (dimethylammonium salt, 2-ethylhexyl ester, isobutyl salt, potassium salt, choline salt), dichlorprop and a salt or ester thereof (butotyl ester, dimethylammonium salt, 2-ethylhexyl ester, isooctyl ester, methyl ester, potassium salt, sodium salt, choline salt), dichlorprop-P, dichlorprop-P-dimethylammonium, bromoxynil, bromoxynil-octanoate, dichlobenil, ioxynil, ioxynil-octanoate, di-allate, butylate, tri-allate, phenmedipham, chlorpropham, asulam, phenisopham, benthiocarb, molinate, esprocarb, pyributicarb, prosulfocarb, orbencarb, EPTC, dimepiperate, swep, propachlor, metazachlor, alachlor, acetochlor, metolachlor, S-metolachlor, butachlor, pretilachlor, thenylchlor, aminocyclopyrachlor, aminocyclopyrachlor-methyl, aminocyclopyrachlor-potassium, trifluralin, pendimethalin, ethalfluralin, benfluralin, prodiamine, simazine, atrazine, propazine, cyanazine, ametryn, simetryn, dimethametryn, prometryn, indaziflam, triaziflam, metribuzin, hexazinone, isoxaben, diflufenican, diuron, linuron, fluometuron, difenoxuron, methyl-daimuron, isoproturon, isouron, tebuthiuron, benzthiazuron, methabenzthiazuron, propanil, mefenacet, clomeprop, naproanilide, bromobutide, daimuron, cumyluron, diflufenzopyr, etobenzanid, bentazon, tridiphane, indanofan, amitrole, fenchlorazole, clomazone, maleic hydrazide, pyridate, chloridazon, norflurazon, bromacil, terbacil, oxaziclomefone, cinmethylin, benfuresate, cafenstrole, pyrithiobac, pyrithiobac-sodium, pyriminobac, pyriminobac-methyl, bispyribac, bispyribac-sodium, pyribenzoxim, pyrimisulfan, pyriftalid, fentrazamide, dimethenamid, dimethenamid-P, ACN, bennzobicyclon, dithiopyr, triclopyr and a salt or ester thereof (butotyl ester, triethylammonium salt), fluroxypyr, fluroxypyr-meptyl, thiazopyr, aminopyralid and a salt thereof (potassium salt, triisopropanolammonium salt, choline salt), clopyralid and a salt thereof (olamine salt, potassium salt, triethylammonium salt, choline salt), picloram and a salt thereof (potassium salt, triisopropanolammonium salt, choline salt), dalapon, chlorthiamid, amidosulfuron, azimsulfuron, bensulfuron, bensulfuron-methyl, chlorimuron, chlorimuron-ethyl, cyclosulfamuron, ethoxysulfuron, flazasulfuron, flucetosulfuron, flupyrsulfuron, flupyrsulfuron-methyl-sodium, foramsulfuron, halosulfuron, halosulfuron-methyl, imazosulfuron, mesosulfuron, mesosulfuron-methyl, nicosulfuron, orthosulfamuron, oxasulfuron, primisulfuron, primisulfuron-methyl, propyrisulfuron, pyrazosulfuron, pyrazosulfuron-ethyl, rimsulfuron, sulfometuron, sulfometuron-methyl, sulfosulfuron, trifloxysulfuron-sodium, trifloxysulfuron, chlorsulfuron, cinosulfuron, ethametsulfuron, ethametsulfuron-methyl, iodosulfuron, iodosulfuron-methyl-sodium, metsulfuron, metsulfuron-methyl, prosulfuron, thifensulfuron, thifensulfuron-methyl, triasulfuron, tribenuron, tribenuron-methyl, triflusulfuron, triflusulfuron-methyl, tritosulfuron, picolinafen, beflubutamid, mesotrione, sulcotrione, tefuryltrione, tembotrione, isoxachlortole, isoxaflutole, benzofenap, pyrasulfotole, pyrazolynate, pyrazoxyfen, topramezone, flupoxam, amicarbazone, bencarbazone, flucarbazone, flucarbazone-sodium, ipfencarbazone, propoxycarbazone, propoxycarbazone-sodium, thiencarbazone, thiencarbazone-methyl, cloransulam, cloransulam-methyl, diclosulam, florasulam, flumetsulam, metosulam, penoxsulam, pyroxsulam, imazamethabenz, imazamethabenz-methyl, imazamox, imazamox-ammonium, imazapic, imazapic-ammonium, imazapyr, imazapyr-ammonium, imazaquin, imazaquin-ammonium, imazethapyr, imazethapyr-ammonium, clodinafop, clodinafop-propargyl, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, propaquizafop, quizalofop, quizalofop-ethyl, quizalofop-P, quizalofop-P-ethyl, alloxydim, clethodim, sethoxydim, tepraloxydim, tralkoxydim, pinoxaden, pyroxasulfone, glyphosate, glyphosate-isopropylamine, glyphosate-trimethylsulfonium, glyphosate-ammonium, glyphosate-diammonium, glyphosate-sodium, glyphosate-potassium, glyphosate-guanidine, glufosinate, glufosinate-ammonium, glufosinate-P, glufosinate-P-sodium, bialafos, anilofos, bensulide, butamifos, paraquat, paraquat-dichloride, diquat anddiquat-dibromide

Plant growth regulating agents: hymexazol, paclobutrazol, uniconazole, uniconazole-P, inabenfide, prohexadione-calcium, 1-methylcyclopropene, trinexapac and gibberellins.

Safeners: benoxacor, cloquintocet, cloquintocet-mexyl, cyometrinil, cyprosulfamide, dichlormid, dicyclonon, dietholate, fenchlorazole, fenchlorazole-ethyl, fenclorim, flurazole, fluxofenim, furilazole, isoxadifen, isoxadifen-ethyl, mefenpyr, mefenpyr-diethyl, mephenate, naphthalic anhydride and oxabetrinil.

### EXAMPLES

The present invention will be described below by way of examples, but the present invention is not limited to these examples. In the following description, “ha” means hectare, that is, 10000 m².

Evaluation criteria of the herbicidal activity and phytotoxicity will be shown below.

### [Herbicidal Activity and Phytotoxicity]

Evaluation of herbicidal activity is classified into 0 to 100, letting no or little difference when the state of germination or growth of a test weed at investigation is compared with that of non-treatment to be “0”, and letting complete withering of a test plant or complete inhibition of germination or growth to be “100”.

Evaluation of phytotoxicity on a crop is classified into 0 to 100, letting no or little difference when the state of growth of a crop at investigation is compared with that of non-treatment to be “0”, and letting complete withering of a crop to be “100”. The “phytotoxicity” evaluated herein is the damage characteristic determined to be due to a treated compound, and is clearly discriminated from the damage characteristic caused by a harmful animal or plant disease.

In the combinations shown in Table 1-19, the herbicidal effect, and phytotoxicity on crops are confirmed by the above standards according to the following methods.

### Example 1

First, microorganisms are adhered on stem cuttings of sugarcane in an active ingredient amount of 10, 25, 50, 100 g/100 kg stem cuttings. Next, a pot is filled with soil, and the stem cuttings and the seeds of the weeds are planted. On the day of the planting, a PPO-inhibiting compound is uniformly applied on the soil surface in an active ingredient amount of 25, 50, 100, 200, and 400 g/ha. This pot is placed in a greenhouse. On day 15 after seeding, the herbicidal activity and phytotoxicity on crops are examined.

### Example 2

First, microorganisms are adhered on stem cuttings of sugarcane in an active ingredient amount of 10, 25, 50, 100 g/100 kg stem cuttings. Next, a pot is filled with soil, and the stem cuttings and the seeds of the weeds are planted. This pot is placed in a greenhouse. Fourteen days of the planting, a PPO-inhibiting compound is uniformly applied on the top of emerged weeds in an active ingredient amount of 25, 50, 100, 200, and 400 g/ha. This pot is placed in a greenhouse. Fifteen days after application of a PPO-inhibiting compound, the herbicidal activity and phytotoxicity on crops are examined.

### Example 3

First, a pot is filled with soil, and the seeds of the weeds are planted. Next, a PPO-inhibiting compound is uniformly applied on the soil surface in an active ingredient amount of 25, 50, 100, 200, and 400 g/ha. This pot is placed in a greenhouse. Then, microorganisms are adhered on stem cuttings of sugarcane in an active ingredient amount of 10, 25, 50, 100 g/100 kg stem cuttings, and the stem cuttings are planted in the pot 14 days after application of a PPO-inhibiting compound. On day 30 after application of a PPO-inhibiting compound, the herbicidal activity and phytotoxicity on crops are examined.

TABLE 1

| Combi- | | PPO-inhibiting |
|---|---|---|
| nation | Microorganism | compound |
| 1-1 | Azospirillum | Flumioxazin |
| | amazonense | |
| 1-2 | Herbaspirillum | Flumioxazin |
| | seropedicae | |
| 1-3 | Herbaspirillum | Flumioxazin |
| | rubrisubalbicans | |
| 1-4 | Burkholderia tropica | Flumioxazin |
| 1-5 | Gluconacetobacter | Flumioxazin |
| | diazotrophicus | |
| 1-6 | Azospirillum | Sulfentrazone |
| | amazonense | |
| 1-7 | Herbaspirillum | Sulfentrazone |
| | seropedicae | |
| 1-8 | Herbaspirillum | Sulfentrazone |
| | rubrisubalbicans | |
| 1-9 | Burkholderia tropica | Sulfentrazone |
| 1-10 | Gluconacetobacter | Sulfentrazone |
| | diazotrophicus | |
| 1-11 | Azospirillum | Saflufenacil |
| | amazonense | |
| 1-12 | Herbaspirillum | Saflufenacil |
| | seropedicae | |
| 1-13 | Herbaspirillum | Saflufenacil |
| | rubrisubalbicans | |
| 1-14 | Burkholderia tropica | Saflufenacil |
| 1-15 | Gluconacetobacter | Saflufenacil |
| | diazotrophicus | |
| 1-16 | Azospirillum | Fomesafen-sodium |
| | amazonense | |
| 1-17 | Herbaspirillum | Fomesafen-sodium |
| | seropedicae | |
| 1-18 | Herbaspirillum | Fomesafen-sodium |
| | rubrisubalbicans | |
| 1-19 | Burkholderia tropica | Fomesafen-sodium |
| 1-20 | Gluconacetobacter | Fomesafen-sodium |
| | diazotrophicus | |
| 1-21 | Azospirillum | oxadiazon |
| | amazonense | |
| 1-22 | Herbaspirillum | oxadiazon |
| | seropedicae | |
| 1-23 | Herbaspirillum | oxadiazon |
| | rubrisubalbicans | |
| 1-24 | Burkholderia tropica | oxadiazon |
| 1-25 | Gluconacetobacter | oxadiazon |
| | diazotrophicus | |
| 1-26 | Azospirillum | Compound 1 |
| | amazonense | |
| 1-27 | Herbaspirillum | Compound 1 |
| | seropedicae | |
| 1-28 | Burkholderia tropica | Compound 1 |
| 1-29 | Herbaspirillum | Compound 1 |
| | rubrisubalbicans | |
| 1-30 | Gluconacetobacter | Compound 1 |
| | diazotrophicus | |

TABLE 2

| Combi- | | | PPO-inhibiting |
|---|---|---|---|
| nation | Microorganism | | compound |
| 2-1 | Azospirillum | Pseudomonas | Flumioxazin |
| | amazonense | fluorescens | |
| 2-2 | Herbaspirillum | Pseudomonas | Flumioxazin |
| | seropedicae | fluorescens | |
| 2-3 | Herbaspirillum | Pseudomonas | Flumioxazin |
| | rubrisubalbicans | fluorescens | |
| 2-4 | Burkholderia | Pseudomonas | Flumioxazin |
| | tropica | fluorescens | |
| 2-5 | Gluconacetobacter | Pseudomonas | Flumioxazin |
| | diazotrophicus | fluorescens | |
| 2-6 | Azospirillum | Pseudomonas | Sulfentrazone |
| | amazonense | fluorescens | |
| 2-7 | Herbaspirillum | Pseudomonas | Sulfentrazone |
| | seropedicae | fluorescens | |
| 2-8 | Herbaspirillum | Pseudomonas | Sulfentrazone |
| | rubrisubalbicans | fluorescens | |
| 2-9 | Burkholderia | Pseudomonas | Sulfentrazone |
| | tropica | fluorescens | |
| 2-10 | Gluconacetobacter | Pseudomonas | Sulfentrazone |
| | diazotrophicus | fluorescens | |
| 2-11 | Azospirillum | Pseudomonas | Saflufenacil |
| | amazonense | fluorescens | |
| 2-12 | Herbaspirillum | Pseudomonas | Saflufenacil |
| | seropedicae | fluorescens | |
| 2-13 | Herbaspirillum | Pseudomonas | Saflufenacil |
| | rubrisubalbicans | fluorescens | |
| 2-14 | Burkholderia | Pseudomonas | Saflufenacil |
| | tropica | fluorescens | |
| 2-15 | Gluconacetobacter | Pseudomonas | Saflufenacil |
| | diazotrophicus | fluorescens | |
| 2-16 | Azospirillum | Pseudomonas | Fomesafen-sodium |
| | amazonense | fluorescens | |
| 2-17 | Herbaspirillum | Pseudomonas | Fomesafen-sodium |
| | seropedicae | fluorescens | |
| 2-18 | Herbaspirillum | Pseudomonas | Fomesafen-sodium |
| | rubrisubalbicans | fluorescens | |
| 2-19 | Burkholderia | Pseudomonas | Fomesafen-sodium |
| | tropica | fluorescens | |
| 2-20 | Gluconacetobacter | Pseudomonas | Fomesafen-sodium |
| | diazotrophicus | fluorescens | |
| 2-21 | Azospirillum | Pseudomonas | oxadiazon |
| | amazonense | fluorescens | |
| 2-22 | Herbaspirillum | Pseudomonas | oxadiazon |
| | seropedicae | fluorescens | |
| 2-23 | Herbaspirillum | Pseudomonas | oxadiazon |
| | rubrisubalbicans | fluorescens | |
| 2-24 | Burkholderia | Pseudomonas | oxadiazon |
| | tropica | fluorescens | |
| 2-25 | Gluconacetobacter | Pseudomonas | oxadiazon |
| | diazotrophicus | fluorescens | |
| 2-26 | Azospirillum | Pseudomonas | Compound 1 |
| | amazonense | fluorescens | |
| 2-27 | Herbaspirillum | Pseudomonas | Compound 1 |
| | seropedicae | fluorescens | |
| 2-28 | Burkholderia | Pseudomonas | Compound 1 |
| | tropica | fluorescens | |
| 2-29 | Herbaspirillum | Pseudomonas | Compound 1 |
| | rubrisubalbicans | fluorescens | |
| 2-30 | Gluconacetobacter | Pseudomonas | Compound 1 |
| | diazotrophicus | fluorescens | |

TABLE 3

| Combi- | | | PPO-inhibiting |
|---|---|---|---|
| nation | Microorganism | | compound |
| 3-1 | Azospirillum | Pseudomonas putida | Flumioxazin |
| | amazonense | | |
| 3-2 | Herbaspirillum | Pseudomonas putida | Flumioxazin |
| | seropedicae | | |
| 3-3 | Herbaspirillum | Pseudomonas putida | Flumioxazin |
| | rubrisubalbicans | | |
| 3-4 | Burkholderia | Pseudomonas putida | Flumioxazin |
| | tropica | | |
| 3-5 | Gluconacetobacter | Pseudomonas putida | Flumioxazin |
| | diazotrophicus | | |
| 3-6 | Azospirillum | Pseudomonas putida | Sulfentrazone |
| | amazonense | | |
| 3-7 | Herbaspirillum | Pseudomonas putida | Sulfentrazone |
| | seropedicae | | |
| 3-8 | Herbaspirillum | Pseudomonas putida | Sulfentrazone |
| | rubrisubalbicans | | |
| 3-9 | Burkholderia | Pseudomonas putida | Sulfentrazone |
| | tropica | | |
| 3-10 | Gluconacetobacter | Pseudomonas putida | Sulfentrazone |
| | diazotrophicus | | |
| 3-11 | Azospirillum | Pseudomonas putida | Saflufenacil |
| | amazonense | | |
| 3-12 | Herbaspirillum | Pseudomonas putida | Saflufenacil |
| | seropedicae | | |
| 3-13 | Herbaspirillum | Pseudomonas putida | Saflufenacil |
| | rubrisubalbicans | | |
| 3-14 | Burkholderia | Pseudomonas putida | Saflufenacil |
| | tropica | | |
| 3-15 | Gluconacetobacter | Pseudomonas putida | Saflufenacil |
| | diazotrophicus | | |
| 3-16 | Azospirillum | Pseudomonas putida | Fomesafen-sodium |
| | amazonense | | |
| 3-17 | Herbaspirillum | Pseudomonas putida | Fomesafen-sodium |
| | seropedicae | | |
| 3-18 | Herbaspirillum | Pseudomonas putida | Fomesafen-sodium |
| | rubrisubalbicans | | |
| 3-19 | Burkholderia | Pseudomonas putida | Fomesafen-sodium |
| | tropica | | |
| 3-20 | Gluconacetobacter | Pseudomonas putida | Fomesafen-sodium |
| | diazotrophicus | | |
| 3-21 | Azospirillum | Pseudomonas putida | oxadiazon |
| | amazonense | | |
| 3-22 | Herbaspirillum | Pseudomonas putida | oxadiazon |
| | seropedicae | | |
| 3-23 | Herbaspirillum | Pseudomonas putida | oxadiazon |
| | rubrisubalbicans | | |
| 3-24 | Burkholderia | Pseudomonas putida | oxadiazon |
| | tropica | | |
| 3-25 | Gluconacetobacter | Pseudomonas putida | oxadiazon |
| | diazotrophicus | | |
| 3-26 | Azospirillum | Pseudomonas putida | Compound 1 |
| | amazonense | | |
| 3-27 | Herbaspirillum | Pseudomonas putida | Compound 1 |
| | seropedicae | | |
| 3-28 | Burkholderia | Pseudomonas putida | Compound 1 |
| | tropica | | |
| 3-29 | Herbaspirillum | Pseudomonas putida | Compound 1 |
| | rubrisubalbicans | | |
| 3-30 | Gluconacetobacter | Pseudomonas putida | Compound 1 |
| | diazotrophicus | | |

TABLE 4

| Combi- | | | PPO-inhibiting |
|---|---|---|---|
| nation | Microorganism | | compound |
| 4-1 | Azospirillum | Streptomyces | Flumioxazin |
| | amazonense | griseus | |
| 4-2 | Herbaspirillum | Streptomyces | Flumioxazin |
| | seropedicae | griseus | |
| 4-3 | Herbaspirillum | Streptomyces | Flumioxazin |
| | rubrisubalbicans | griseus | |
| 4-4 | Burkholderia | Streptomyces | Flumioxazin |
| | tropica | griseus | |
| 4-5 | Gluconacetobacter | Streptomyces | Flumioxazin |
| | diazotrophicus | griseus | |
| 4-6 | Azospirillum | Streptomyces | Sulfentrazone |
| | amazonense | griseus | |
| 4-7 | Herbaspirillum | Streptomyces | Sulfentrazone |
| | seropedicae | griseus | |
| 4-8 | Herbaspirillum | Streptomyces | Sulfentrazone |
| | rubrisubalbicans | griseus | |
| 4-9 | Burkholderia | Streptomyces | Sulfentrazone |
| | tropica | griseus | |
| 4-10 | Gluconacetobacter | Streptomyces | Sulfentrazone |
| | diazotrophicus | griseus | |
| 4-11 | Azospirillum | Streptomyces | Saflufenacil |
| | amazonense | griseus | |
| 4-12 | Herbaspirillum | Streptomyces | Saflufenacil |
| | seropedicae | griseus | |
| 4-13 | Herbaspirillum | Streptomyces | Saflufenacil |
| | rubrisubalbicans | griseus | |
| 4-14 | Burkholderia | Streptomyces | Saflufenacil |
| | tropica | griseus | |
| 4-15 | Gluconacetobacter | Streptomyces | Saflufenacil |
| | diazotrophicus | griseus | |
| 4-16 | Azospirillum | Streptomyces | Fomesafen-sodium |
| | amazonense | griseus | |
| 4-17 | Herbaspirillum | Streptomyces | Fomesafen-sodium |
| | seropedicae | griseus | |
| 4-18 | Herbaspirillum | Streptomyces | Fomesafen-sodium |
| | rubrisubalbicans | griseus | |
| 4-19 | Burkholderia | Streptomyces | Fomesafen-sodium |
| | tropica | griseus | |
| 4-20 | Gluconacetobacter | Streptomyces | Fomesafen-sodium |
| | diazotrophicus | griseus | |
| 4-21 | Azospirillum | Streptomyces | oxadiazon |
| | amazonense | griseus | |
| 4-22 | Herbaspirillum | Streptomyces | oxadiazon |
| | seropedicae | griseus | |
| 4-23 | Herbaspirillum | Streptomyces | oxadiazon |
| | rubrisubalbicans | griseus | |
| 4-24 | Burkholderia | Streptomyces | oxadiazon |
| | tropica | griseus | |
| 4-25 | Gluconacetobacter | Streptomyces | oxadiazon |
| | diazotrophicus | griseus | |
| 4-26 | Azospirillum | Streptomyces | Compound 1 |
| | amazonense | griseus | |
| 4-27 | Herbaspirillum | Streptomyces | Compound 1 |
| | seropedicae | griseus | |
| 4-28 | Burkholderia | Streptomyces | Compound 1 |
| | tropica | griseus | |
| 4-29 | Herbaspirillum | Streptomyces | Compound 1 |
| | rubrisubalbicans | griseus | |
| 4-30 | Gluconacetobacter | Streptomyces | Compound 1 |
| | diazotrophicus | griseus | |

TABLE 5

| Combi- | | | PPO-inhibiting |
|---|---|---|---|
| nation | Microorganism | | compound |
| 5-1 | Azospirillum | Streptomyces | Flumioxazin |
| | amazonense | ochraceisleroticus | |
| 5-2 | Herbaspirillum | Streptomyces | Flumioxazin |
| | seropedicae | ochraceisleroticus | |
| 5-3 | Herbaspirillum | Streptomyces | Flumioxazin |
| | rubrisubalbicans | ochraceisleroticus | |
| 5-4 | Burkholderia | Streptomyces | Flumioxazin |
| | tropica | ochraceisleroticus | |
| 5-5 | Gluconacetobacter | Streptomyces | Flumioxazin |
| | diazotrophicus | ochraceisleroticus | |
| 5-6 | Azospirillum | Streptomyces | Sulfentrazone |
| | amazonense | ochraceisleroticus | |
| 5-7 | Herbaspirillum | Streptomyces | Sulfentrazone |
| | seropedicae | ochraceisleroticus | |
| 5-8 | Herbaspirillum | Streptomyces | Sulfentrazone |
| | rubrisubalbicans | ochraceisleroticus | |
| 5-9 | Burkholderia | Streptomyces | Sulfentrazone |
| | tropica | ochraceisleroticus | |
| 5-10 | Gluconacetobacter | Streptomyces | Sulfentrazone |
| | diazotrophicus | ochraceisleroticus | |
| 5-11 | Azospirillum | Streptomyces | Saflufenacil |
| | amazonense | ochraceisleroticus | |
| 5-12 | Herbaspirillum | Streptomyces | Saflufenacil |
| | seropedicae | ochraceisleroticus | |
| 5-13 | Herbaspirillum | Streptomyces | Saflufenacil |
| | rubrisubalbicans | ochraceisleroticus | |
| 5-14 | Burkholderia | Streptomyces | Saflufenacil |
| | tropica | ochraceisleroticus | |
| 5-15 | Gluconacetobacter | Streptomyces | Saflufenacil |
| | diazotrophicus | ochraceisleroticus | |
| 5-16 | Azospirillum | Streptomyces | Fomesafen-sodium |
| | amazonense | ochraceisleroticus | |
| 5-17 | Herbaspirillum | Streptomyces | Fomesafen-sodium |
| | seropedicae | ochraceisleroticus | |
| 5-18 | Herbaspirillum | Streptomyces | Fomesafen-sodium |
| | rubrisubalbicans | ochraceisleroticus | |
| 5-19 | Burkholderia | Streptomyces | Fomesafen-sodium |
| | tropica | ochraceisleroticus | |
| 5-20 | Gluconacetobacter | Streptomyces | Fomesafen-sodium |
| | diazotrophicus | ochraceisleroticus | |
| 5-21 | Azospirillum | Streptomyces | oxadiazon |
| | amazonense | ochraceisleroticus | |
| 5-22 | Herbaspirillum | Streptomyces | oxadiazon |
| | seropedicae | ochraceisleroticus | |
| 5-23 | Herbaspirillum | Streptomyces | oxadiazon |
| | rubrisubalbicans | ochraceisleroticus | |
| 5-24 | Burkholderia | Streptomyces | oxadiazon |
| | tropica | ochraceisleroticus | |
| 5-25 | Gluconacetobacter | Streptomyces | oxadiazon |
| | diazotrophicus | ochraceisleroticus | |
| 5-26 | Azospirillum | Streptomyces | Compound 1 |
| | amazonense | ochraceisleroticus | |
| 5-27 | Herbaspirillum | Streptomyces | Compound 1 |
| | seropedicae | ochraceisleroticus | |
| 5-28 | Burkholderia | Streptomyces | Compound 1 |
| | tropica | ochraceisleroticus | |
| 5-29 | Herbaspirillum | Streptomyces | Compound 1 |
| | rubrisubalbicans | ochraceisleroticus | |
| 5-30 | Gluconacetobacter | Streptomyces | Compound 1 |
| | diazotrophicus | ochraceisleroticus | |

TABLE 6

| Combi- | | | PPO-inhibiting |
|---|---|---|---|
| nation | Microorganism | | compound |
| 6-1 | Azospirillum | Streptomyces | Flumioxazin |
| | amazonense | graminofaciens | |
| 6-2 | Herbaspirillum | Streptomyces | Flumioxazin |
| | seropedicae | graminofaciens | |
| 6-3 | Herbaspirillum | Streptomyces | Flumioxazin |
| | rubrisubalbicans | graminofaciens | |
| 6-4 | Burkholderia | Streptomyces | Flumioxazin |
| | tropica | graminofaciens | |
| 6-5 | Gluconacetobacter | Streptomyces | Flumioxazin |
| | diazotrophicus | graminofaciens | |
| 6-6 | Azospirillum | Streptomyces | Sulfentrazone |
| | amazonense | graminofaciens | |
| 6-7 | Herbaspirillum | Streptomyces | Sulfentrazone |
| | seropedicae | graminofaciens | |
| 6-8 | Herbaspirillum | Streptomyces | Sulfentrazone |
| | rubrisubalbicans | graminofaciens | |
| 6-9 | Burkholderia | Streptomyces | Sulfentrazone |
| | tropica | graminofaciens | |
| 6-10 | Gluconacetobacter | Streptomyces | Sulfentrazone |
| | diazotrophicus | graminofaciens | |
| 6-11 | Azospirillum | Streptomyces | Saflufenacil |
| | amazonense | graminofaciens | |
| 6-12 | Herbaspirillum | Streptomyces | Saflufenacil |
| | seropedicae | graminofaciens | |
| 6-13 | Herbaspirillum | Streptomyces | Saflufenacil |
| | rubrisubalbicans | graminofaciens | |
| 6-14 | Burkholderia | Streptomyces | Saflufenacil |
| | tropica | graminofaciens | |
| 6-15 | Gluconacetobacter | Streptomyces | Saflufenacil |
| | diazotrophicus | graminofaciens | |
| 6-16 | Azospirillum | Streptomyces | Fomesafen-sodium |
| | amazonense | graminofaciens | |
| 6-17 | Herbaspirillum | Streptomyces | Fomesafen-sodium |
| | seropedicae | graminofaciens | |
| 6-18 | Herbaspirillum | Streptomyces | Fomesafen-sodium |
| | rubrisubalbicans | graminofaciens | |
| 6-19 | Burkholderia | Streptomyces | Fomesafen-sodium |
| | tropica | graminofaciens | |
| 6-20 | Gluconacetobacter | Streptomyces | Fomesafen-sodium |
| | diazotrophicus | graminofaciens | |
| 6-21 | Azospirillum | Streptomyces | oxadiazon |
| | amazonense | graminofaciens | |
| 6-22 | Herbaspirillum | Streptomyces | oxadiazon |
| | seropedicae | graminofaciens | |
| 6-23 | Herbaspirillum | Streptomyces | oxadiazon |
| | rubrisubalbicans | graminofaciens | |
| 6-24 | Burkholderia | Streptomyces | oxadiazon |
| | tropica | graminofaciens | |
| 6-25 | Gluconacetobacter | Streptomyces | oxadiazon |
| | diazotrophicus | graminofaciens | |
| 6-26 | Azospirillum | Streptomyces | Compound 1 |
| | amazonense | graminofaciens | |
| 6-27 | Herbaspirillum | Streptomyces | Compound 1 |
| | seropedicae | graminofaciens | |
| 6-28 | Burkholderia | Streptomyces | Compound 1 |
| | tropica | graminofaciens | |
| 6-29 | Herbaspirillum | Streptomyces | Compound 1 |
| | rubrisubalbicans | graminofaciens | |
| 6-30 | Gluconacetobacter | Streptomyces | Compound 1 |
| | diazotrophicus | graminofaciens | |

TABLE 7

| Combi- | | | PPO-inhibiting |
|---|---|---|---|
| nation | Microorganism | | compound |
| 7-1 | Azospirillum | Streptomyces | Flumioxazin |
| | amazonense | corchousii | |
| 7-2 | Herbaspirillum | Streptomyces | Flumioxazin |
| | seropedicae | corchousii | |
| 7-3 | Herbaspirillum | Streptomyces | Flumioxazin |
| | rubrisubalbicans | corchousii | |
| 7-4 | Burkholderia | Streptomyces | Flumioxazin |
| | tropica | corchousii | |
| 7-5 | Gluconacetobacter | Streptomyces | Flumioxazin |
| | diazotrophicus | corchousii | |
| 7-6 | Azospirillum | Streptomyces | Sulfentrazone |
| | amazonense | corchousii | |
| 7-7 | Herbaspirillum | Streptomyces | Sulfentrazone |
| | seropedicae | corchousii | |
| 7-8 | Herbaspirillum | Streptomyces | Sulfentrazone |
| | rubrisubalbicans | corchousii | |
| 7-9 | Burkholderia | Streptomyces | Sulfentrazone |
| | tropica | corchousii | |
| 7-10 | Gluconacetobacter | Streptomyces | Sulfentrazone |
| | diazotrophicus | corchousii | |
| 7-11 | Azospirillum | Streptomyces | Saflufenacil |
| | amazonense | corchousii | |
| 7-12 | Herbaspirillum | Streptomyces | Saflufenacil |
| | seropedicae | corchousii | |
| 7-13 | Herbaspirillum | Streptomyces | Saflufenacil |
| | rubrisubalbicans | corchousii | |
| 7-14 | Burkholderia | Streptomyces | Saflufenacil |
| | tropica | corchousii | |
| 7-15 | Gluconacetobacter | Streptomyces | Saflufenacil |
| | diazotrophicus | corchousii | |
| 7-16 | Azospirillum | Streptomyces | Fomesafen-sodium |
| | amazonense | corchousii | |
| 7-17 | Herbaspirillum | Streptomyces | Fomesafen-sodium |
| | seropedicae | corchousii | |
| 7-18 | Herbaspirillum | Streptomyces | Fomesafen-sodium |
| | rubrisubalbicans | corchousii | |
| 7-19 | Burkholderia | Streptomyces | Fomesafen-sodium |
| | tropica | corchousii | |
| 7-20 | Gluconacetobacter | Streptomyces | Fomesafen-sodium |
| | diazotrophicus | corchousii | |
| 7-21 | Azospirillum | Streptomyces | oxadiazon |
| | amazonense | corchousii | |
| 7-22 | Herbaspirillum | Streptomyces | oxadiazon |
| | seropedicae | corchousii | |
| 7-23 | Herbaspirillum | Streptomyces | oxadiazon |
| | rubrisubalbicans | corchousii | |
| 7-24 | Burkholderia | Streptomyces | oxadiazon |
| | tropica | corchousii | |
| 7-25 | Gluconacetobacter | Streptomyces | oxadiazon |
| | diazotrophicus | corchousii | |
| 7-26 | Azospirillum | Streptomyces | Compound 1 |
| | amazonense | corchousii | |
| 7-27 | Herbaspirillum | Streptomyces | Compound 1 |
| | seropedicae | corchousii | |
| 7-28 | Burkholderia | Streptomyces | Compound 1 |
| | tropica | corchousii | |
| 7-29 | Herbaspirillum | Streptomyces | Compound 1 |
| | rubrisubalbicans | corchousii | |
| 7-30 | Gluconacetobacter | Streptomyces | Compound 1 |
| | diazotrophicus | corchousii | |

TABLE 8

| Combi- | | | PPO-inhibiting |
|---|---|---|---|
| nation | Microorganism | | compound |
| 8-1 | Azospirillum | Streptomyces | Flumioxazin |
| | amazonense | spiroverticillatus | |
| 8-2 | Herbaspirillum | Streptomyces | Flumioxazin |
| | seropedicae | spiroverticillatus | |
| 8-3 | Herbaspirillum | Streptomyces | Flumioxazin |
| | rubrisubalbicans | spiroverticillatus | |
| 8-4 | Burkholderia | Streptomyces | Flumioxazin |
| | tropica | spiroverticillatus | |
| 8-5 | Gluconacetobacter | Streptomyces | Flumioxazin |
| | diazotrophicus | spiroverticillatus | |
| 8-6 | Azospirillum | Streptomyces | Sulfentrazone |
| | amazonense | spiroverticillatus | |
| 8-7 | Herbaspirillum | Streptomyces | Sulfentrazone |
| | seropedicae | spiroverticillatus | |
| 8-8 | Herbaspirillum | Streptomyces | Sulfentrazone |
| | rubrisubalbicans | spiroverticillatus | |
| 8-9 | Burkholderia | Streptomyces | Sulfentrazone |
| | tropica | spiroverticillatus | |
| 8-10 | Gluconacetobacter | Streptomyces | Sulfentrazone |
| | diazotrophicus | spiroverticillatus | |
| 8-11 | Azospirillum | Streptomyces | Saflufenacil |
| | amazonense | spiroverticillatus | |
| 8-12 | Herbaspirillum | Streptomyces | Saflufenacil |
| | seropedicae | spiroverticillatus | |
| 8-13 | Herbaspirillum | Streptomyces | Saflufenacil |
| | rubrisubalbicans | spiroverticillatus | |
| 8-14 | Burkholderia | Streptomyces | Saflufenacil |
| | tropica | spiroverticillatus | |
| 8-15 | Gluconacetobacter | Streptomyces | Saflufenacil |
| | diazotrophicus | spiroverticillatus | |
| 8-16 | Azospirillum | Streptomyces | Fomesafen-sodium |
| | amazonense | spiroverticillatus | |
| 8-17 | Herbaspirillum | Streptomyces | Fomesafen-sodium |
| | seropedicae | spiroverticillatus | |
| 8-18 | Herbaspirillum | Streptomyces | Fomesafen-sodium |
| | rubrisubalbicans | spiroverticillatus | |
| 8-19 | Burkholderia | Streptomyces | Fomesafen-sodium |
| | tropica | spiroverticillatus | |
| 8-20 | Gluconacetobacter | Streptomyces | Fomesafen-sodium |
| | diazotrophicus | spiroverticillatus | |
| 8-21 | Azospirillum | Streptomyces | oxadiazon |
| | amazonense | spiroverticillatus | |
| 8-22 | Herbaspirillum | Streptomyces | oxadiazon |
| | seropedicae | spiroverticillatus | |
| 8-23 | Herbaspirillum | Streptomyces | oxadiazon |
| | rubrisubalbicans | spiroverticillatus | |
| 8-24 | Burkholderia | Streptomyces | oxadiazon |
| | tropica | spiroverticillatus | |
| 8-25 | Gluconacetobacter | Streptomyces | oxadiazon |
| | diazotrophicus | spiroverticillatus | |
| 8-26 | Azospirillum | Streptomyces | Compound 1 |
| | amazonense | spiroverticillatus | |
| 8-27 | Herbaspirillum | Streptomyces | Compound 1 |
| | seropedicae | spiroverticillatus | |
| 8-28 | Burkholderia | Streptomyces | Compound 1 |
| | tropica | spiroverticillatus | |
| 8-29 | Herbaspirillum | Streptomyces | Compound 1 |
| | rubrisubalbicans | spiroverticillatus | |
| 8-30 | Gluconacetobacter | Streptomyces | Compound 1 |
| | diazotrophicus | spiroverticillatus | |

TABLE 9

| Combi- | | | PPO-inhibiting |
|---|---|---|---|
| nation | Microorganism | | compound |
| 9-1 | Azospirillum | Streptomyces | Flumioxazin |
| | amazonense | griseovirdis | |
| 9-2 | Herbaspirillum | Streptomyces | Flumioxazin |
| | seropedicae | griseovirdis | |
| 9-3 | Herbaspirillum | Streptomyces | Flumioxazin |
| | rubrisubalbicans | griseovirdis | |
| 9-4 | Burkholderia | Streptomyces | Flumioxazin |
| | tropica | griseovirdis | |
| 9-5 | Gluconacetobacter | Streptomyces | Flumioxazin |
| | diazotrophicus | griseovirdis | |
| 9-6 | Azospirillum | Streptomyces | Sulfentrazone |
| | amazonense | griseovirdis | |
| 9-7 | Herbaspirillum | Streptomyces | Sulfentrazone |
| | seropedicae | griseovirdis | |
| 9-8 | Herbaspirillum | Streptomyces | Sulfentrazone |
| | rubrisubalbicans | griseovirdis | |
| 9-9 | Burkholderia | Streptomyces | Sulfentrazone |
| | tropica | griseovirdis | |
| 9-10 | Gluconacetobacter | Streptomyces | Sulfentrazone |
| | diazotrophicus | griseovirdis | |
| 9-11 | Azospirillum | Streptomyces | Saflufenacil |
| | amazonense | griseovirdis | |
| 9-12 | Herbaspirillum | Streptomyces | Saflufenacil |
| | seropedicae | griseovirdis | |
| 9-13 | Herbaspirillum | Streptomyces | Saflufenacil |
| | rubrisubalbicans | griseovirdis | |
| 9-14 | Burkholderia | Streptomyces | Saflufenacil |
| | tropica | griseovirdis | |
| 9-15 | Gluconacetobacter | Streptomyces | Saflufenacil |
| | diazotrophicus | griseovirdis | |
| 9-16 | Azospirillum | Streptomyces | Fomesafen-sodium |
| | amazonense | griseovirdis | |
| 9-17 | Herbaspirillum | Streptomyces | Fomesafen-sodium |
| | seropedicae | griseovirdis | |
| 9-18 | Herbaspirillum | Streptomyces | Fomesafen-sodium |
| | rubrisubalbicans | griseovirdis | |
| 9-19 | Burkholderia | Streptomyces | Fomesafen-sodium |
| | tropica | griseovirdis | |
| 9-20 | Gluconacetobacter | Streptomyces | Fomesafen-sodium |
| | diazotrophicus | griseovirdis | |
| 9-21 | Azospirillum | Streptomyces | oxadiazon |
| | amazonense | griseovirdis | |
| 9-22 | Herbaspirillum | Streptomyces | oxadiazon |
| | seropedicae | griseovirdis | |
| 9-23 | Herbaspirillum | Streptomyces | oxadiazon |
| | rubrisubalbicans | griseovirdis | |
| 9-24 | Burkholderia | Streptomyces | oxadiazon |
| | tropica | griseovirdis | |
| 9-25 | Gluconacetobacter | Streptomyces | oxadiazon |
| | diazotrophicus | griseovirdis | |
| 9-26 | Azospirillum | Streptomyces | Compound 1 |
| | amazonense | griseovirdis | |
| 9-27 | Herbaspirillum | Streptomyces | Compound 1 |
| | seropedicae | griseovirdis | |
| 9-28 | Burkholderia | Streptomyces | Compound 1 |
| | tropica | griseovirdis | |
| 9-29 | Herbaspirillum | Streptomyces | Compound 1 |
| | rubrisubalbicans | griseovirdis | |
| 9-30 | Gluconacetobacter | Streptomyces | Compound 1 |
| | diazotrophicus | griseovirdis | |

TABLE 10

| Combi- | | | PPO-inhibiting |
|---|---|---|---|
| nation | Microorganism | | compound |
| 10-1 | Azospirillum | Streptomyces | Flumioxazin |
| | amazonense | hygroscopicus | |
| 10-2 | Herbaspirillum | Streptomyces | Flumioxazin |
| | seropedicae | hygroscopicus | |
| 10-3 | Herbaspirillum | Streptomyces | Flumioxazin |
| | rubrisubalbicans | hygroscopicus | |
| 10-4 | Burkholderia | Streptomyces | Flumioxazin |
| | tropica | hygroscopicus | |
| 10-5 | Gluconacetobacter | Streptomyces | Flumioxazin |
| | diazotrophicus | hygroscopicus | |
| 10-6 | Azospirillum | Streptomyces | Sulfentrazone |
| | amazonense | hygroscopicus | |
| 10-7 | Herbaspirillum | Streptomyces | Sulfentrazone |
| | seropedicae | hygroscopicus | |
| 10-8 | Herbaspirillum | Streptomyces | Sulfentrazone |
| | rubrisubalbicans | hygroscopicus | |
| 10-9 | Burkholderia | Streptomyces | Sulfentrazone |
| | tropica | hygroscopicus | |
| 10-10 | Gluconacetobacter | Streptomyces | Sulfentrazone |
| | diazotrophicus | hygroscopicus | |
| 10-11 | Azospirillum | Streptomyces | Saflufenacil |
| | amazonense | hygroscopicus | |
| 10-12 | Herbaspirillum | Streptomyces | Saflufenacil |
| | seropedicae | hygroscopicus | |
| 10-13 | Herbaspirillum | Streptomyces | Saflufenacil |
| | rubrisubalbicans | hygroscopicus | |
| 10-14 | Burkholderia | Streptomyces | Saflufenacil |
| | tropica | hygroscopicus | |
| 10-15 | Gluconacetobacter | Streptomyces | Saflufenacil |
| | diazotrophicus | hygroscopicus | |
| 10-16 | Azospirillum | Streptomyces | Fomesafen-sodium |
| | amazonense | hygroscopicus | |
| 10-17 | Herbaspirillum | Streptomyces | Fomesafen-sodium |
| | seropedicae | hygroscopicus | |
| 10-18 | Herbaspirillum | Streptomyces | Fomesafen-sodium |
| | rubrisubalbicans | hygroscopicus | |
| 10-19 | Burkholderia | Streptomyces | Fomesafen-sodium |
| | tropica | hygroscopicus | |
| 10-20 | Gluconacetobacter | Streptomyces | Fomesafen-sodium |
| | diazotrophicus | hygroscopicus | |
| 10-21 | Azospirillum | Streptomyces | oxadiazon |
| | amazonense | hygroscopicus | |
| 10-22 | Herbaspirillum | Streptomyces | oxadiazon |
| | seropedicae | hygroscopicus | |
| 10-23 | Herbaspirillum | Streptomyces | oxadiazon |
| | rubrisubalbicans | hygroscopicus | |
| 10-24 | Burkholderia | Streptomyces | oxadiazon |
| | tropica | hygroscopicus | |
| 10-25 | Gluconacetobacter | Streptomyces | oxadiazon |
| | diazotrophicus | hygroscopicus | |
| 10-26 | Azospirillum | Streptomyces | Compound 1 |
| | amazonense | hygroscopicus | |
| 10-27 | Herbaspirillum | Streptomyces | Compound 1 |
| | seropedicae | hygroscopicus | |
| 10-28 | Burkholderia | Streptomyces | Compound 1 |
| | tropica | hygroscopicus | |
| 10-29 | Herbaspirillum | Streptomyces | Compound 1 |
| | rubrisubalbicans | hygroscopicus | |
| 10-30 | Gluconacetobacter | Streptomyces | Compound 1 |
| | diazotrophicus | hygroscopicus | |

TABLE 11

| Combi- | | | PPO-inhibiting |
|---|---|---|---|
| nation | Microorganism | | compound |
| 11-1 | Azospirillum | Bacillus subtilis | Flumioxazin |
| | amazonense | | |
| 11-2 | Herbaspirillum | Bacillus subtilis | Flumioxazin |
| | seropedicae | | |
| 11-3 | Herbaspirillum | Bacillus subtilis | Flumioxazin |
| | rubrisubalbicans | | |
| 11-4 | Burkholderia | Bacillus subtilis | Flumioxazin |
| | tropica | | |
| 11-5 | Gluconacetobacter | Bacillus subtilis | Flumioxazin |
| | diazotrophicus | | |
| 11-6 | Azospirillum | Bacillus subtilis | Sulfentrazone |
| | amazonense | | |
| 11-7 | Herbaspirillum | Bacillus subtilis | Sulfentrazone |
| | seropedicae | | |
| 11-8 | Herbaspirillum | Bacillus subtilis | Sulfentrazone |
| | rubrisubalbicans | | |
| 11-9 | Burkholderia | Bacillus subtilis | Sulfentrazone |
| | tropica | | |
| 11-10 | Gluconacetobacter | Bacillus subtilis | Sulfentrazone |
| | diazotrophicus | | |
| 11-11 | Azospirillum | Bacillus subtilis | Saflufenacil |
| | amazonense | | |
| 11-12 | Herbaspirillum | Bacillus subtilis | Saflufenacil |
| | seropedicae | | |
| 11-13 | Herbaspirillum | Bacillus subtilis | Saflufenacil |
| | rubrisubalbicans | | |
| 11-14 | Burkholderia | Bacillus subtilis | Saflufenacil |
| | tropica | | |
| 11-15 | Gluconacetobacter | Bacillus subtilis | Saflufenacil |
| | diazotrophicus | | |
| 11-16 | Azospirillum | Bacillus subtilis | Fomesafen-sodium |
| | amazonense | | |
| 11-17 | Herbaspirillum | Bacillus subtilis | Fomesafen-sodium |
| | seropedicae | | |
| 11-18 | Herbaspirillum | Bacillus subtilis | Fomesafen-sodium |
| | rubrisubalbicans | | |
| 11-19 | Burkholderia | Bacillus subtilis | Fomesafen-sodium |
| | tropica | | |
| 11-20 | Gluconacetobacter | Bacillus subtilis | Fomesafen-sodium |
| | diazotrophicus | | |
| 11-21 | Azospirillum | Bacillus subtilis | oxadiazon |
| | amazonense | | |
| 11-22 | Herbaspirillum | Bacillus subtilis | oxadiazon |
| | seropedicae | | |
| 11-23 | Herbaspirillum | Bacillus subtilis | oxadiazon |
| | rubrisubalbicans | | |
| 11-24 | Burkholderia | Bacillus subtilis | oxadiazon |
| | tropica | | |
| 11-25 | Gluconacetobacter | Bacillus subtilis | oxadiazon |
| | diazotrophicus | | |
| 11-26 | Azospirillum | Bacillus subtilis | Compound 1 |
| | amazonense | | |
| 11-27 | Herbaspirillum | Bacillus subtilis | Compound 1 |
| | seropedicae | | |
| 11-28 | Burkholderia | Bacillus subtilis | Compound 1 |
| | tropica | | |
| 11-29 | Herbaspirillum | Bacillus subtilis | Compound 1 |
| | rubrisubalbicans | | |
| 11-30 | Gluconacetobacter | Bacillus subtilis | Compound 1 |
| | diazotrophicus | | |

TABLE 12

| Combi- | | | PPO-inhibiting |
|---|---|---|---|
| nation | Microorganism | | compound |
| 12-1 | Azospirillum | Bacillus cereus | Flumioxazin |
| | amazonense | | |
| 12-2 | Herbaspirillum | Bacillus cereus | Flumioxazin |
| | seropedicae | | |
| 12-3 | Herbaspirillum | Bacillus cereus | Flumioxazin |
| | rubrisubalbicans | | |
| 12-4 | Burkholderia | Bacillus cereus | Flumioxazin |
| | tropica | | |
| 12-5 | Gluconacetobacter | Bacillus cereus | Flumioxazin |
| | diazotrophicus | | |
| 12-6 | Azospirillum | Bacillus cereus | Sulfentrazone |
| | amazonense | | |
| 12-7 | Herbaspirillum | Bacillus cereus | Sulfentrazone |
| | seropedicae | | |
| 12-8 | Herbaspirillum | Bacillus cereus | Sulfentrazone |
| | rubrisubalbicans | | |
| 12-9 | Burkholderia | Bacillus cereus | Sulfentrazone |
| | tropica | | |
| 12-10 | Gluconacetobacter | Bacillus cereus | Sulfentrazone |
| | diazotrophicus | | |
| 12-11 | Azospirillum | Bacillus cereus | Saflufenacil |
| | amazonense | | |
| 12-12 | Herbaspirillum | Bacillus cereus | Saflufenacil |
| | seropedicae | | |
| 12-13 | Herbaspirillum | Bacillus cereus | Saflufenacil |
| | rubrisubalbicans | | |
| 12-14 | Burkholderia | Bacillus cereus | Saflufenacil |
| | tropica | | |
| 12-15 | Gluconacetobacter | Bacillus cereus | Saflufenacil |
| | diazotrophicus | | |
| 12-16 | Azospirillum | Bacillus cereus | Fomesafen-sodium |
| | amazonense | | |
| 12-17 | Herbaspirillum | Bacillus cereus | Fomesafen-sodium |
| | seropedicae | | |
| 12-18 | Herbaspirillum | Bacillus cereus | Fomesafen-sodium |
| | rubrisubalbicans | | |
| 12-19 | Burkholderia | Bacillus cereus | Fomesafen-sodium |
| | tropica | | |
| 12-20 | Gluconacetobacter | Bacillus cereus | Fomesafen-sodium |
| | diazotrophicus | | |
| 12-21 | Azospirillum | Bacillus cereus | oxadiazon |
| | amazonense | | |
| 12-22 | Herbaspirillum | Bacillus cereus | oxadiazon |
| | seropedicae | | |
| 12-23 | Herbaspirillum | Bacillus cereus | oxadiazon |
| | rubrisubalbicans | | |
| 12-24 | Burkholderia | Bacillus cereus | oxadiazon |
| | tropica | | |
| 12-25 | Gluconacetobacter | Bacillus cereus | oxadiazon |
| | diazotrophicus | | |
| 12-26 | Azospirillum | Bacillus cereus | Compound 1 |
| | amazonense | | |
| 12-27 | Herbaspirillum | Bacillus cereus | Compound 1 |
| | seropedicae | | |
| 12-28 | Burkholderia | Bacillus cereus | Compound 1 |
| | tropica | | |
| 12-29 | Herbaspirillum | Bacillus cereus | Compound 1 |
| | rubrisubalbicans | | |
| 12-30 | Gluconacetobacter | Bacillus cereus | Compound 1 |
| | diazotrophicus | | |

TABLE 13

| Combi- | | | PPO-inhibiting |
|---|---|---|---|
| nation | Microorganism | | compound |
| 13-1 | Azospirillum | Bacillus mycoides | Flumioxazin |
| | amazonense | | |
| 13-2 | Herbaspirillum | Bacillus mycoides | Flumioxazin |
| | seropedicae | | |
| 13-3 | Herbaspirillum | Bacillus mycoides | Flumioxazin |
| | rubrisubalbicans | | |
| 13-4 | Burkholderia | Bacillus mycoides | Flumioxazin |
| | tropica | | |
| 13-5 | Gluconacetobacter | Bacillus mycoides | Flumioxazin |
| | diazotrophicus | | |
| 13-6 | Azospirillum | Bacillus mycoides | Sulfentrazone |
| | amazonense | | |
| 13-7 | Herbaspirillum | Bacillus mycoides | Sulfentrazone |
| | seropedicae | | |
| 13-8 | Herbaspirillum | Bacillus mycoides | Sulfentrazone |
| | rubrisubalbicans | | |
| 13-9 | Burkholderia | Bacillus mycoides | Sulfentrazone |
| | tropica | | |
| 13-10 | Gluconacetobacter | Bacillus mycoides | Sulfentrazone |
| | diazotrophicus | | |
| 13-11 | Azospirillum | Bacillus mycoides | Saflufenacil |
| | amazonense | | |
| 13-12 | Herbaspirillum | Bacillus mycoides | Saflufenacil |
| | seropedicae | | |
| 13-13 | Herbaspirillum | Bacillus mycoides | Saflufenacil |
| | rubrisubalbicans | | |
| 13-14 | Burkholderia | Bacillus mycoides | Saflufenacil |
| | tropica | | |
| 13-15 | Gluconacetobacter | Bacillus mycoides | Saflufenacil |
| | diazotrophicus | | |
| 13-16 | Azospirillum | Bacillus mycoides | Fomesafen-sodium |
| | amazonense | | |
| 13-17 | Herbaspirillum | Bacillus mycoides | Fomesafen-sodium |
| | seropedicae | | |
| 13-18 | Herbaspirillum | Bacillus mycoides | Fomesafen-sodium |
| | rubrisubalbicans | | |
| 13-19 | Burkholderia | Bacillus mycoides | Fomesafen-sodium |
| | tropica | | |
| 13-20 | Gluconacetobacter | Bacillus mycoides | Fomesafen-sodium |
| | diazotrophicus | | |
| 13-21 | Azospirillum | Bacillus mycoides | oxadiazon |
| | amazonense | | |
| 13-22 | Herbaspirillum | Bacillus mycoides | oxadiazon |
| | seropedicae | | |
| 13-23 | Herbaspirillum | Bacillus mycoides | oxadiazon |
| | rubrisubalbicans | | |
| 13-24 | Burkholderia | Bacillus mycoides | oxadiazon |
| | tropica | | |
| 13-25 | Gluconacetobacter | Bacillus mycoides | oxadiazon |
| | diazotrophicus | | |
| 13-26 | Azospirillum | Bacillus mycoides | Compound 1 |
| | amazonense | | |
| 13-27 | Herbaspirillum | Bacillus mycoides | Compound 1 |
| | seropedicae | | |
| 13-28 | Burkholderia | Bacillus mycoides | Compound 1 |
| | tropica | | |
| 13-29 | Herbaspirillum | Bacillus mycoides | Compound 1 |
| | rubrisubalbicans | | |
| 13-30 | Gluconacetobacter | Bacillus mycoides | Compound 1 |
| | diazotrophicus | | |

TABLE 14

| Combi- | | | PPO-inhibiting |
|---|---|---|---|
| nation | Microorganism | | compound |
| 14-1 | Azospirillum | Bacillus pumilus | Flumioxazin |
| | amazonense | | |
| 14-2 | Herbaspirillum | Bacillus pumilus | Flumioxazin |
| | seropedicae | | |
| 14-3 | Herbaspirillum | Bacillus pumilus | Flumioxazin |
| | rubrisubalbicans | | |
| 14-4 | Burkholderia | Bacillus pumilus | Flumioxazin |
| | tropica | | |
| 14-5 | Gluconacetobacter | Bacillus pumilus | Flumioxazin |
| | diazotrophicus | | |
| 14-6 | Azospirillum | Bacillus pumilus | Sulfentrazone |
| | amazonense | | |
| 14-7 | Herbaspirillum | Bacillus pumilus | Sulfentrazone |
| | seropedicae | | |
| 14-8 | Herbaspirillum | Bacillus pumilus | Sulfentrazone |
| | rubrisubalbicans | | |
| 14-9 | Burkholderia | Bacillus pumilus | Sulfentrazone |
| | tropica | | |
| 14-10 | Gluconacetobacter | Bacillus pumilus | Sulfentrazone |
| | diazotrophicus | | |
| 14-11 | Azospirillum | Bacillus pumilus | Saflufenacil |
| | amazonense | | |
| 14-12 | Herbaspirillum | Bacillus pumilus | Saflufenacil |
| | seropedicae | | |
| 14-13 | Herbaspirillum | Bacillus pumilus | Saflufenacil |
| | rubrisubalbicans | | |
| 14-14 | Burkholderia | Bacillus pumilus | Saflufenacil |
| | tropica | | |
| 14-15 | Gluconacetobacter | Bacillus pumilus | Saflufenacil |
| | diazotrophicus | | |
| 14-16 | Azospirillum | Bacillus pumilus | Fomesafen-sodium |
| | amazonense | | |
| 14-17 | Herbaspirillum | Bacillus pumilus | Fomesafen-sodium |
| | seropedicae | | |
| 14-18 | Herbaspirillum | Bacillus pumilus | Fomesafen-sodium |
| | rubrisubalbicans | | |
| 14-19 | Burkholderia | Bacillus pumilus | Fomesafen-sodium |
| | tropica | | |
| 14-20 | Gluconacetobacter | Bacillus pumilus | Fomesafen-sodium |
| | diazotrophicus | | |
| 14-21 | Azospirillum | Bacillus pumilus | oxadiazon |
| | amazonense | | |
| 14-22 | Herbaspirillum | Bacillus pumilus | oxadiazon |
| | seropedicae | | |
| 14-23 | Herbaspirillum | Bacillus pumilus | oxadiazon |
| | rubrisubalbicans | | |
| 14-24 | Burkholderia | Bacillus pumilus | oxadiazon |
| | tropica | | |
| 14-25 | Gluconacetobacter | Bacillus pumilus | oxadiazon |
| | diazotrophicus | | |
| 14-26 | Azospirillum | Bacillus pumilus | Compound 1 |
| | amazonense | | |
| 14-27 | Herbaspirillum | Bacillus pumilus | Compound 1 |
| | seropedicae | | |
| 14-28 | Burkholderia | Bacillus pumilus | Compound 1 |
| | tropica | | |
| 14-29 | Herbaspirillum | Bacillus pumilus | Compound 1 |
| | rubrisubalbicans | | |
| 14-30 | Gluconacetobacter | Bacillus pumilus | Compound 1 |
| | diazotrophicus | | |

TABLE 15

| Combi- | | | PPO-inhibiting |
|---|---|---|---|
| nation | Microorganism | | compound |
| 15-1 | Azospirillum | Bacillus | Flumioxazin |
| | amazonense | licheniformis | |
| 15-2 | Herbaspirillum | Bacillus | Flumioxazin |
| | seropedicae | licheniformis | |
| 15-3 | Herbaspirillum | Bacillus | Flumioxazin |
| | rubrisubalbicans | licheniformis | |
| 15-4 | Burkholderia | Bacillus | Flumioxazin |
| | tropica | licheniformis | |
| 15-5 | Gluconacetobacter | Bacillus | Flumioxazin |
| | diazotrophicus | licheniformis | |
| 15-6 | Azospirillum | Bacillus | Sulfentrazone |
| | amazonense | licheniformis | |
| 15-7 | Herbaspirillum | Bacillus | Sulfentrazone |
| | seropedicae | licheniformis | |
| 15-8 | Herbaspirillum | Bacillus | Sulfentrazone |
| | rubrisubalbicans | licheniformis | |
| 15-9 | Burkholderia | Bacillus | Sulfentrazone |
| | tropica | licheniformis | |
| 15-10 | Gluconacetobacter | Bacillus | Sulfentrazone |
| | diazotrophicus | licheniformis | |
| 15-11 | Azospirillum | Bacillus | Saflufenacil |
| | amazonense | licheniformis | |
| 15-12 | Herbaspirillum | Bacillus | Saflufenacil |
| | seropedicae | licheniformis | |
| 15-13 | Herbaspirillum | Bacillus | Saflufenacil |
| | rubrisubalbicans | licheniformis | |
| 15-14 | Burkholderia | Bacillus | Saflufenacil |
| | tropica | licheniformis | |
| 15-15 | Gluconacetobacter | Bacillus | Saflufenacil |
| | diazotrophicus | licheniformis | |
| 15-16 | Azospirillum | Bacillus | Fomesafen-sodium |
| | amazonense | licheniformis | |
| 15-17 | Herbaspirillum | Bacillus | Fomesafen-sodium |
| | seropedicae | licheniformis | |
| 15-18 | Herbaspirillum | Bacillus | Fomesafen-sodium |
| | rubrisubalbicans | licheniformis | |
| 15-19 | Burkholderia | Bacillus | Fomesafen-sodium |
| | tropica | licheniformis | |
| 15-20 | Gluconacetobacter | Bacillus | Fomesafen-sodium |
| | diazotrophicus | licheniformis | |
| 15-21 | Azospirillum | Bacillus | oxadiazon |
| | amazonense | licheniformis | |
| 15-22 | Herbaspirillum | Bacillus | oxadiazon |
| | seropedicae | licheniformis | |
| 15-23 | Herbaspirillum | Bacillus | oxadiazon |
| | rubrisubalbicans | licheniformis | |
| 15-24 | Burkholderia | Bacillus | oxadiazon |
| | tropica | licheniformis | |
| 15-25 | Gluconacetobacter | Bacillus | oxadiazon |
| | diazotrophicus | licheniformis | |
| 15-26 | Azospirillum | Bacillus | Compound 1 |
| | amazonense | licheniformis | |
| 15-27 | Herbaspirillum | Bacillus | Compound 1 |
| | seropedicae | licheniformis | |
| 15-28 | Burkholderia | Bacillus | Compound 1 |
| | tropica | licheniformis | |
| 15-29 | Herbaspirillum | Bacillus | Compound 1 |
| | rubrisubalbicans | licheniformis | |
| 15-30 | Gluconacetobacter | Bacillus | Compound 1 |
| | diazotrophicus | licheniformis | |

TABLE 16

| Combi- | | | PPO-inhibiting |
|---|---|---|---|
| nation | Microorganism | | compound |
| 16-1 | Azospirillum | Bacillus | Flumioxazin |
| | amazonense | thuringiensis | |
| 16-2 | Herbaspirillum | Bacillus | Flumioxazin |
| | seropedicae | thuringiensis | |
| 16-3 | Herbaspirillum | Bacillus | Flumioxazin |
| | rubrisubalbicans | thuringiensis | |
| 16-4 | Burkholderia | Bacillus | Flumioxazin |
| | tropica | thuringiensis | |
| 16-5 | Gluconacetobacter | Bacillus | Flumioxazin |
| | diazotrophicus | thuringiensis | |
| 16-6 | Azospirillum | Bacillus | Sulfentrazone |
| | amazonense | thuringiensis | |
| 16-7 | Herbaspirillum | Bacillus | Sulfentrazone |
| | seropedicae | thuringiensis | |
| 16-8 | Herbaspirillum | Bacillus | Sulfentrazone |
| | rubrisubalbicans | thuringiensis | |
| 16-9 | Burkholderia | Bacillus | Sulfentrazone |
| | tropica | thuringiensis | |
| 16-10 | Gluconacetobacter | Bacillus | Sulfentrazone |
| | diazotrophicus | thuringiensis | |
| 16-11 | Azospirillum | Bacillus | Saflufenacil |
| | amazonense | thuringiensis | |
| 16-12 | Herbaspirillum | Bacillus | Saflufenacil |
| | seropedicae | thuringiensis | |
| 16-13 | Herbaspirillum | Bacillus | Saflufenacil |
| | rubrisubalbicans | thuringiensis | |
| 16-14 | Burkholderia | Bacillus | Saflufenacil |
| | tropica | thuringiensis | |
| 16-15 | Gluconacetobacter | Bacillus | Saflufenacil |
| | diazotrophicus | thuringiensis | |
| 16-16 | Azospirillum | Bacillus | Fomesafen-sodium |
| | amazonense | thuringiensis | |
| 16-17 | Herbaspirillum | Bacillus | Fomesafen-sodium |
| | seropedicae | thuringiensis | |
| 16-18 | Herbaspirillum | Bacillus | Fomesafen-sodium |
| | rubrisubalbicans | thuringiensis | |
| 16-19 | Burkholderia | Bacillus | Fomesafen-sodium |
| | tropica | thuringiensis | |
| 16-20 | Gluconacetobacter | Bacillus | Fomesafen-sodium |
| | diazotrophicus | thuringiensis | |
| 16-21 | Azospirillum | Bacillus | oxadiazon |
| | amazonense | thuringiensis | |
| 16-22 | Herbaspirillum | Bacillus | oxadiazon |
| | seropedicae | thuringiensis | |
| 16-23 | Herbaspirillum | Bacillus | oxadiazon |
| | rubrisubalbicans | thuringiensis | |
| 16-24 | Burkholderia | Bacillus | oxadiazon |
| | tropica | thuringiensis | |
| 16-25 | Gluconacetobacter | Bacillus | oxadiazon |
| | diazotrophicus | thuringiensis | |
| 16-26 | Azospirillum | Bacillus | Compound 1 |
| | amazonense | thuringiensis | |
| 16-27 | Herbaspirillum | Bacillus | Compound 1 |
| | seropedicae | thuringiensis | |
| 16-28 | Burkholderia | Bacillus | Compound 1 |
| | tropica | thuringiensis | |
| 16-29 | Herbaspirillum | Bacillus | Compound 1 |
| | rubrisubalbicans | thuringiensis | |
| 16-30 | Gluconacetobacter | Bacillus | Compound 1 |
| | diazotrophicus | thuringiensis | |

TABLE 17

| Combi- | | | PPO-inhibiting |
|---|---|---|---|
| nation | Microorganism | | compound |
| 17-1 | Azospirillum | Trichoderma | Flumioxazin |
| | amazonense | harzianum | |
| 17-2 | Herbaspirillum | Trichoderma | Flumioxazin |
| | seropedicae | harzianum | |
| 17-3 | Herbaspirillum | Trichoderma | Flumioxazin |
| | rubrisubalbicans | harzianum | |
| 17-4 | Burkholderia | Trichoderma | Flumioxazin |
| | tropica | harzianum | |
| 17-5 | Gluconacetobacter | Trichoderma | Flumioxazin |
| | diazotrophicus | harzianum | |
| 17-6 | Azospirillum | Trichoderma | Sulfentrazone |
| | amazonense | harzianum | |
| 17-7 | Herbaspirillum | Trichoderma | Sulfentrazone |
| | seropedicae | harzianum | |
| 17-8 | Herbaspirillum | Trichoderma | Sulfentrazone |
| | rubrisubalbicans | harzianum | |
| 17-9 | Burkholderia | Trichoderma | Sulfentrazone |
| | tropica | harzianum | |
| 17-10 | Gluconacetobacter | Trichoderma | Sulfentrazone |
| | diazotrophicus | harzianum | |
| 17-11 | Azospirillum | Trichoderma | Saflufenacil |
| | amazonense | harzianum | |
| 17-12 | Herbaspirillum | Trichoderma | Saflufenacil |
| | seropedicae | harzianum | |
| 17-13 | Herbaspirillum | Trichoderma | Saflufenacil |
| | rubrisubalbicans | harzianum | |
| 17-14 | Burkholderia | Trichoderma | Saflufenacil |
| | tropica | harzianum | |
| 17-15 | Gluconacetobacter | Trichoderma | Saflufenacil |
| | diazotrophicus | harzianum | |
| 17-16 | Azospirillum | Trichoderma | Fomesafen-sodium |
| | amazonense | harzianum | |
| 17-17 | Herbaspirillum | Trichoderma | Fomesafen-sodium |
| | seropedicae | harzianum | |
| 17-18 | Herbaspirillum | Trichoderma | Fomesafen-sodium |
| | rubrisubalbicans | harzianum | |
| 17-19 | Burkholderia | Trichoderma | Fomesafen-sodium |
| | tropica | harzianum | |
| 17-20 | Gluconacetobacter | Trichoderma | Fomesafen-sodium |
| | diazotrophicus | harzianum | |
| 17-21 | Azospirillum | Trichoderma | oxadiazon |
| | amazonense | harzianum | |
| 17-22 | Herbaspirillum | Trichoderma | oxadiazon |
| | seropedicae | harzianum | |
| 17-23 | Herbaspirillum | Trichoderma | oxadiazon |
| | rubrisubalbicans | harzianum | |
| 17-24 | Burkholderia | Trichoderma | oxadiazon |
| | tropica | harzianum | |
| 17-25 | Gluconacetobacter | Trichoderma | oxadiazon |
| | diazotrophicus | harzianum | |
| 17-26 | Azospirillum | Trichoderma | Compound 1 |
| | amazonense | harzianum | |
| 17-27 | Herbaspirillum | Trichoderma | Compound 1 |
| | seropedicae | harzianum | |
| 17-28 | Burkholderia | Trichoderma | Compound 1 |
| | tropica | harzianum | |
| 17-29 | Herbaspirillum | Trichoderma | Compound 1 |
| | rubrisubalbicans | harzianum | |
| 17-30 | Gluconacetobacter | Trichoderma | Compound 1 |
| | diazotrophicus | harzianum | |

TABLE 18

| Combi- | | | PPO-inhibiting |
|---|---|---|---|
| nation | Microorganism | | compound |
| 18-1 | Azospirillum | Trichoderma viride | Flumioxazin |
| | amazonense | | |
| 18-2 | Herbaspirillum | Trichoderma viride | Flumioxazin |
| | seropedicae | | |
| 18-3 | Herbaspirillum | Trichoderma viride | Flumioxazin |
| | rubrisubalbicans | | |
| 18-4 | Burkholderia | Trichoderma viride | Flumioxazin |
| | tropica | | |
| 18-5 | Gluconacetobacter | Trichoderma viride | Flumioxazin |
| | diazotrophicus | | |
| 18-6 | Azospirillum | Trichoderma viride | Sulfentrazone |
| | amazonense | | |
| 18-7 | Herbaspirillum | Trichoderma viride | Sulfentrazone |
| | seropedicae | | |
| 18-8 | Herbaspirillum | Trichoderma viride | Sulfentrazone |
| | rubrisubalbicans | | |
| 18-9 | Burkholderia | Trichoderma viride | Sulfentrazone |
| | tropica | | |
| 18-10 | Gluconacetobacter | Trichoderma viride | Sulfentrazone |
| | diazotrophicus | | |
| 18-11 | Azospirillum | Trichoderma viride | Saflufenacil |
| | amazonense | | |
| 18-12 | Herbaspirillum | Trichoderma viride | Saflufenacil |
| | seropedicae | | |
| 18-13 | Herbaspirillum | Trichoderma viride | Saflufenacil |
| | rubrisubalbicans | | |
| 18-14 | Burkholderia | Trichoderma viride | Saflufenacil |
| | tropica | | |
| 18-15 | Gluconacetobacter | Trichoderma viride | Saflufenacil |
| | diazotrophicus | | |
| 18-16 | Azospirillum | Trichoderma viride | Fomesafen-sodium |
| | amazonense | | |
| 18-17 | Herbaspirillum | Trichoderma viride | Fomesafen-sodium |
| | seropedicae | | |
| 18-18 | Herbaspirillum | Trichoderma viride | Fomesafen-sodium |
| | rubrisubalbicans | | |
| 18-19 | Burkholderia | Trichoderma viride | Fomesafen-sodium |
| | tropica | | |
| 18-20 | Gluconacetobacter | Trichoderma viride | Fomesafen-sodium |
| | diazotrophicus | | |
| 18-21 | Azospirillum | Trichoderma viride | oxadiazon |
| | amazonense | | |
| 18-22 | Herbaspirillum | Trichoderma viride | oxadiazon |
| | seropedicae | | |
| 18-23 | Herbaspirillum | Trichoderma viride | oxadiazon |
| | rubrisubalbicans | | |
| 18-24 | Burkholderia | Trichoderma viride | oxadiazon |
| | tropica | | |
| 18-25 | Gluconacetobacter | Trichoderma viride | oxadiazon |
| | diazotrophicus | | |
| 18-26 | Azospirillum | Trichoderma viride | Compound 1 |
| | amazonense | | |
| 18-27 | Herbaspirillum | Trichoderma viride | Compound 1 |
| | seropedicae | | |
| 18-28 | Burkholderia | Trichoderma viride | Compound 1 |
| | tropica | | |
| 18-29 | Herbaspirillum | Trichoderma viride | Compound 1 |
| | rubrisubalbicans | | |
| 18-30 | Gluconacetobacter | Trichoderma viride | Compound 1 |
| | diazotrophicus | | |

TABLE 19

| Combi- | | | PPO-inhibiting |
|---|---|---|---|
| nation | Microorganism | | compound |
| 19-1 | Azospirillum | Sporidesmium | Flumioxazin |
| | amazonense | sclerotiorum | |
| 19-2 | Herbaspirillum | Sporidesmium | Flumioxazin |
| | seropedicae | sclerotiorum | |
| 19-3 | Herbaspirillum | Sporidesmium | Flumioxazin |
| | rubrisubalbicans | sclerotiorum | |
| 19-4 | Burkholderia | Sporidesmium | Flumioxazin |
| | tropica | sclerotiorum | |
| 19-5 | Gluconacetobacter | Sporidesmium | Flumioxazin |
| | diazotrophicus | sclerotiorum | |
| 19-6 | Azospirillum | Sporidesmium | Sulfentrazone |
| | amazonense | sclerotiorum | |
| 19-7 | Herbaspirillum | Sporidesmium | Sulfentrazone |
| | seropedicae | sclerotiorum | |
| 19-8 | Herbaspirillum | Sporidesmium | Sulfentrazone |
| | rubrisubalbicans | sclerotiorum | |
| 19-9 | Burkholderia | Sporidesmium | Sulfentrazone |
| | tropica | sclerotiorum | |
| 19-10 | Gluconacetobacter | Sporidesmium | Sulfentrazone |
| | diazotrophicus | sclerotiorum | |
| 19-11 | Azospirillum | Sporidesmium | Saflufenacil |
| | amazonense | sclerotiorum | |
| 19-12 | Herbaspirillum | Sporidesmium | Saflufenacil |
| | seropedicae | sclerotiorum | |
| 19-13 | Herbaspirillum | Sporidesmium | Saflufenacil |
| | rubrisubalbicans | sclerotiorum | |
| 19-14 | Burkholderia | Sporidesmium | Saflufenacil |
| | tropica | sclerotiorum | |
| 19-15 | Gluconacetobacter | Sporidesmium | Saflufenacil |
| | diazotrophicus | sclerotiorum | |
| 19-16 | Azospirillum | Sporidesmium | Fomesafen-sodium |
| | amazonense | sclerotiorum | |
| 19-17 | Herbaspirillum | Sporidesmium | Fomesafen-sodium |
| | seropedicae | sclerotiorum | |
| 19-18 | Herbaspirillum | Sporidesmium | Fomesafen-sodium |
| | rubrisubalbicans | sclerotiorum | |
| 19-19 | Burkholderia | Sporidesmium | Fomesafen-sodium |
| | tropica | sclerotiorum | |
| 19-20 | Gluconacetobacter | Sporidesmium | Fomesafen-sodium |
| | diazotrophicus | sclerotiorum | |
| 19-21 | Azospirillum | Sporidesmium | oxadiazon |
| | amazonense | sclerotiorum | |
| 19-22 | Herbaspirillum | Sporidesmium | oxadiazon |
| | seropedicae | sclerotiorum | |
| 19-23 | Herbaspirillum | Sporidesmium | oxadiazon |
| | rubrisubalbicans | sclerotiorum | |
| 19-24 | Burkholderia | Sporidesmium | oxadiazon |
| | tropica | sclerotiorum | |
| 19-25 | Gluconacetobacter | Sporidesmium | oxadiazon |
| | diazotrophicus | sclerotiorum | |
| 19-26 | Azospirillum | Sporidesmium | Compound 1 |
| | amazonense | sclerotiorum | |
| 19-27 | Herbaspirillum | Sporidesmium | Compound 1 |
| | seropedicae | sclerotiorum | |
| 19-28 | Burkholderia | Sporidesmium | Compound 1 |
| | tropica | sclerotiorum | |
| 19-29 | Herbaspirillum | Sporidesmium | Compound 1 |
| | rubrisubalbicans | sclerotiorum | |
| 19-30 | Gluconacetobacter | Sporidesmium | Compound 1 |
| | diazotrophicus | sclerotiorum | |

According to the method of the present invention, a weed in a sugarcane field can be controlled, without causing significant phytotoxicity on sugarcane.

In addition, according to the method of present invention, it becomes possible to increase the yield of sugarcane and the yield of sugar from a plant of sugarcane.

What is claimed is:

1. A method of controlling a weed in a sugarcane field, comprising applying one or more PPO-inhibiting compounds selected from Group A to a field before, at or after planting a stem cutting of sugarcane treated with one or more microorganisms selected from the group consisting of Gluconacetobacter species, Herbaspirilum species, Azospirilum species, and Burkholderia species, wherein Group A is a group consisting of flumioxazin, sulfentrazone, saflufenacil, oxyfluorfen, fomesafen, oxadiazon and a compound represented by the formula (I):

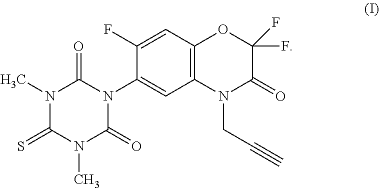 [SMILES: C#CCN1C(=O)C(F)(F)Oc2cc(F)c(-n3c(=O)n(C)c(=S)n(C)c3=O)cc21]

2. The method according to claim 1, wherein the one or more microorganisms is selected from the group consisting of Azospirillum amazonense, Herbaspirillum seropedicae, Herbaspirillum rubrisubalbicans, Burkholderia tropica and Gluconacetobacter diazotrophicus.

3. The method according to claim 1, wherein the stem cutting of sugarcane is further treated with one or more microorganisms selected from the group consisting of Pseudomonas fluorescens, Pseudomonas putida, Streptomyces griseus, Streptomyces ochraceisleroticus, Streptomyces graminofaciens, Streptomyces corchousii, Streptomyces spiroverticillatus, Streptomyces griseovirdis, Streptomyces hygroscopicus, Bacillus subtilis, Bacillus cereus, Bacillus mycoides, Bacillus pumilus, Bacillus licheniformis, Bacillus thuringiensis, Trichoderma harzianum, Trichoderma viride and Sporidesmium sclerotiorum.

4. The method according to claim 1, wherein the one or more PPO-inhibiting compound is flumioxazin.

5. The method according to claim 3, wherein the one or more PPO-inhibiting compound is flumioxazin.
